(19) United States
(12) Patent Application Publication
(10) Pub. No.: US 2026/0156421 A1
(43) Pub. Date: Jun. 4, 2026

(54) HEARING AID SYSTEM COMPRISING AN AUXILIARY SOUND PROCESSOR FOR PROVIDING A SIMULATED AUDIO SIGNAL

(71) Applicant: Oticon A/S, Smørum (DK)

(72) Inventors: Florine Lena BACHMANN, Smørum (DK); Emina ALICKOVIC, Smørum (DK); Simon WITH, Smørum (DK)

(21) Appl. No.: 19/346,583

(22) Filed: Oct. 1, 2025

(30) Foreign Application Priority Data
Oct. 11, 2024 (EP) 24206016.8

(51) Int. Cl. H04R 25/00

(52) U.S. Cl. CPC H04R 25/43; H04R 25/507; H04R 25/552; H04R 25/554; H04R 25/70; H04R 2225/39; H04R 2225/41; H04R 2225/43; H04R 2225/61

(57) ABSTRACT

Disclosed herein is a hearing aid system having a user interface configured to provide a listening difficulty indication based on an interaction with a user. The listening difficulty indication is indicative of the user's listening difficulty in the sound environment. The hearing aid system further can include an auxiliary sound processor. The auxiliary sound processor is configured to provide a simulated audio signal based on the listening difficulty indication and a plurality of acoustic features.

### CROSS REFERENCE TO RELATED APPLICATIONS

Any and all application for which a foreign or domestic priority claim is identified in the Application Data Sheet as filed with the present application are hereby incorporated by reference under 37 CFR 1.57.

### TECHNICAL FIELD

The present application relates to the field of sound processing for hearing aid systems and hearing aids. The present application further relates to the field of sound synthesis with the use of deep learning.

### BACKGROUND

Hearing aid users have highly individual hearing abilities and needs, but hearing aid fitting often fails to reflect this individuality. Personalization is limited by the lack of precise information about sound environments where hearing aid users struggle, i.e., when their current hearing device adjustments are insufficient for their environmental and cognitive needs and the detailed nature of said struggle (i.e., which aspects are hard to capture).

### SUMMARY

A hearing aid user may indicate a challenging listening situation, in which they wish to improve speech understanding or ease of speech understanding, to a hearing aid system. At this cue, the hearing aid system may comprise a hearing aid and an auxiliary device configured to, either one or both, collect information about the challenging listening situation. The collected information may be information related to the sound environment such as parameters from a voice detector, voice characteristics, frequency characteristics of the sound environment, the sound field of the sound environment etc., and prepare a simulated audio or audiovisual signal simulating the challenging situation. The hearing aid user may then use the simulated audio signal for practice or test their hearing during a practice or test session initiated by themselves.

The hearing aid user may initiate a test or practice session. The test or practice session may use the collected information to provide a simulated audio (or audiovisual) signal simulating real-world sound environments. The collected information is used to ensure that the simulated audio signal closely represents the sound environment which the hearing aid user finds particularly difficult and wish to improve, for example, speech understanding in particular types of noise or speech understanding for particular types of voice. During the practice session, the simulated audio signal is presented as an audio stimulus to the hearing aid user through the hearing aid receivers (i.e. loudspeakers) and being heard by the hearing aid user. The hearing aid user may be tasked to perform a test or a questionnaire in relation to the heard audio stimulus. The results from the test or questionnaire may be used to determine a user performance score indicative of the hearing aid user's speech understanding, or listening effort, or cognitive load, etc. The user performance score and the corresponding simulated audio signal may be stored on the hearing aid system during or after the practice or test session. The stored user performance scores and corresponding simulated audio (or audiovisual) signal may be used to provide insights into a hearing aid user's struggles in related challenging listening situation. For example, the user performance score may be used to generate statistics, to provide hearing health insights, where the hearing aid user or a hearing care professional can monitor the progress over time of the hearing aid user's hearing health or comfort level in noisy sound environments. In another aspect, the user performance score may be used to provide hearing aid fitting, such that parameters on the hearing aid (e.g. parameters in relation to noise reduction, hearing loss compensation, feedback management, etc.) can be personalized, i.e., modifying the parameters based on the user performance score.

An advantage of the present disclosure is personalization of the simulated audio (or audiovisual) signal for the hearing aid user. In the present disclosure, the hearing aid system may provide the simulated audio signal based on utilizing personalization data indicative of the hearing aid user's hearing health or physical characteristics. The personalization data may include, but not limited to, the head-related transfer function, the hearing aid user's voice characteristics, audiograms, speech-in-noise tests, prescribed noise reduction and hearing loss compensation settings, hearing aid style, pinnae shape, etc. The personalization data may be obtained in a sound studio, at a hearing care professional, manually provided by the hearing aid user, or automatically through a personalization test by, for instance, an app on a smart device.

In an exemplary practice or test setup, the audio training material offered in hearing aid clinics with the help of a hearing care professional, are based on standardized pre-defined speech material recorded by a trained speaker in static noise (e.g. colored noise, simple background noise) thus not representing real-world situations which the hearing aid user experiences. Hence, the benefits gained from testing or practicing hearing at a hearing aid clinic using standardized speech material may be limiting, since they do not represent real-world sound environments. This may eventually lead to 1) the hearing aid user potentially only improving speech understanding in specific situations only present in the standardized speech material, or 2) inaccurate fittings of the hearing aid due to unrealistic nature of the standardized speech material. Hence, the present disclosure provides a hearing aid system and method for solving this problem.

An advantage of the present disclosure is that the practice or test session can be initiated by the hearing aid user themselves without the help of a hearing care professional, e.g., an audiologist. This gives flexibility to the hearing aid user to practice their hearing at any time during the day at their own convenience.

One of the advantages of the present disclosure is the flexibility for customizing aspects of the simulated audio (or audiovisual) signal to represent the challenging listening situations compared to typical audio training material at a hearing care professional. The hearing aid system may be configured to use the collected information to simulate a similar sound environment to the sound environment in the challenging listening environment, such that the simulated audio signal has similar acoustic characteristics to the challenging listening environment. The collected information may include, but not limited to, noise types like competing speakers in the background, music, traffic sounds, or changing sound levels of noise, phonemes of a desired speech sound, speech pace, fundamental frequency of the desired speech etc. An advantage of the present disclosure is that the hearing aid user may practice without the supervision or presence of a hearing care professional, and may be able to fit or customize the hearing aid settings independently of an audiologist and based on the user performance score and user preference obtained from the practice session.

### A First Hearing Aid System

In a first aspect of the present disclosure, a hearing aid system comprises an input unit. The input unit comprises an input transducer. The input transducer is configured to provide an audio input signal indicative of sound of a sound environment. A sound environment may comprise sound sources such as humans, musical instruments, loudspeaker, machines, cars, bells, animals, etc. capable of providing sound hearable to humans. An input unit may comprise one or more input transducers configured to pick-up sound. The input transducer may be a microphone. The input unit may comprise an analog-to-digital converter (ADC) configured to convert an electrical signal provided by the input transducer to a digitalized signal. The electrical signal may be representative of picked-up sound. The digitalized signal may be a discrete time-domain signal represented by at least one amplitude and at least one timestamp, i.e., the time-domain signal may be a signal with a time-varying amplitude. The audio input signal may be the digitalized signal.

The picked-up sound by the input transducer may be a mixture signal. The mixture signal may be understood as a signal representing the combination of sounds in the sound environment as picked-up by the input transducer. For example, the mixture signal may comprise a combination of a desired signal and a noise signal. A desired signal may be understood as a signal that is desired to be enhanced or preserved for the hearing aid user. For example, a speech signal articulated by a conversational partner, may be regarded as as a desired signal. A noise signal may be understood as a signal that is undesired for the user and desired to be removed or attenuated based on the mixture signal. For example, a noise signal may comprise background noise, which may refer to combination of noise generated by different noise sources present in the sound environment. The noise signal may include environmental noises such as traffic noise, reverberation, alarms, competing talkers, bioacoustics noise from animals, and electrical noise from devices such as refrigerators, air conditioning, power supplies, motors, etc. The audio input signal may be the mixture signal.

The hearing aid system comprises a user interface. The user interface is configured to provide a listening difficulty indication based on the hearing aid user interacting with the user interface. The listening difficulty indication is indicative of the user's listening difficulty in the sound environment.

The hearing aid system may comprise a hearing aid comprising the user interface. The user interface may comprise a physical button or a physical switch which the hearing aid user may use to interact with the hearing aid. The physical button may be configured to provide the listening difficulty indication. For example, the physical button may be configured to provide a listening difficulty indicative of a high listening difficulty when the physical button is pushed. The physical button may be configured to provide a listening difficulty indicative of a low listening difficulty when the physical button is not pushed. The physical switch may be configured to operate in a first and second switch mode. The physical switch may be in a first position representing the first switch mode indicative of a low listening difficulty. The physical switch may be in a second position representing the second switch mode indicative of a high listening difficulty.

In a particular embodiment, the hearing aid comprises the user interface comprising a physical button, and wherein the physical button, when pushed, outputs a value of ‘1’ representing a high listening difficulty. The physical button outputs a value of ‘0’ when not pushed.

The hearing aid system may comprise an auxiliary device comprising the user interface. The user interface may comprise a virtual button or a virtual switch for interacting with the hearing aid user. The virtual button may be configured to provide the listening difficulty indication. For example, the virtual button may be configured to provide a listening difficulty indicative of a high listening difficulty when the virtual button is pushed. The virtual button may be configured to provide a listening difficulty indicative of a low listening difficulty when the virtual button is not pushed. The virtual button may be a computer-implemented button shown on a computer screen. The hearing aid user may interact with the virtual button for example through a touch screen or a computer mouse or a touch pad. The virtual switch may be configured to operate in a first and second switch mode. The virtual switch may be in a first position representing the first switch mode indicative of a low listening difficulty. The virtual switch may be in a second position representing the second switch mode indicative of a high listening difficulty. The virtual switch may be a computer-implemented switch shown on a computer screen. The hearing aid user may interact with the virtual switch for example through a touch screen or a computer mouse or a touch pad. The user interface may comprise a plurality of virtual buttons or a virtual slider to indicate different degrees of listening difficulties. Each virtual button may indicate different degrees of listening difficulties. The virtual slider may be a computer-implemented slider shown on a computer screen. The hearing aid user may interact with the virtual slider for example through a touch screen or a computer mouse or a touch pad. Each position of the virtual slider may indicate different degrees of listening difficulties.

In a particular embodiment, the auxiliary device is a smart device, such as a smartphone. The auxiliary device may comprise an auxiliary sound processor. The auxiliary sound processor may comprise the user interface. The user interface may be a virtual button. The hearing aid may interact with the virtual button through a touch screen constituting the auxiliary device.

In another embodiment, the user interface may comprise a keyboard, wherein the hearing user may use the keyboard to provide a text sentence indicative of the listening difficulty. The auxiliary device may be configured to provide a listening difficulty indication based on the text sentence. In another embodiment, the user interface may comprise a speech recognition system. The user interface may comprise a microphone configured to pick-up sound and provide a second audio input signal containing speech of the hearing aid user. The speech recognition system may be configured to receive the second audio input signal and determine the listening difficulty indication.

In a particular embodiment, the auxiliary device comprises the user interface comprises a virtual slider, and wherein the virtual slider has a lowest slider position and a highest slider position. The virtual slider outputs a lowest listening difficulty indication when its slider position is at the lowest slider position. The virtual slider outputs a highest listening difficulty indication when its slider position is at the highest slider position. The slider position is determined based on the hearing aid user's interaction with the virtual slider. For example, the hearing aid user may interact with the slider through a touch screen.

The hearing aid system may comprise a body-mounted sensor. The input unit may comprise the body-mounted sensor. The body-mounted sensor may comprise a second type of input transducer configured to measure movement such as acceleration, force, and velocity. The body-mounted sensor may comprise an electroencephalography (EEG) sensor, an electromyography (EMG) sensor, a movement sensor, a temperature sensor, a photoplethysmography (PPG) sensor, a pupillometry sensor, an electrooculography (EOG) sensor configured to pick-up a body signal and provide a sensor signal. The sensor signal may be indicative of the listening difficulty, such as a high listening difficulty or a low listening difficulty. In a particular embodiment, the body-mounted sensor may be an electroencephalography (EEG) sensor configured to pick-up an EEG signal. The EEG signal may be indicative of a high listening difficulty when the parietal alpha power is reduced compared to a normal level of the hearing aid user. In a particular embodiment, the body-mounted sensor may be pupillometry sensor configured to pick-up a pupillometry signal. The pupillometry signal may be indicative of a high listening difficulty when the pupil dilation is increased compared to a normal level of the hearing aid user.

The listening difficulty indication may be indicative of the hearing aid user's struggle to understand speech in the sound environment. The listening difficulty indication may be indicative of the hearing aid user's perception of the noise level in the sound environment. The listening difficulty indication may be a binary value, wherein a value of ‘0’ may be indicative of a low listening difficulty and a value of ‘1’ may be indicative of a high listening difficulty. The listening difficulty indication may be a value between ‘0’ and ‘1’, wherein a value close to ‘0’ may be indicative of a lower listening difficulty and a value close to ‘1’ may be indicative of a higher listening difficulty. The listening difficulty indication may be a value between a lower limit and a higher limit, wherein a value close to the lower limit may be indicative of a lower listening difficulty and a value close to the higher limit may be indicative of a higher listening difficulty.

The hearing aid system comprises an auxiliary sound processor. The auxiliary sound processor is configured to provide a simulated audio signal based on the listening difficulty indication and a plurality of acoustic features. The auxiliary sound processor is configured to determine the plurality of acoustic features based on the audio input signal. Each of the plurality of acoustic features is indicative of an acoustic characteristic of the sound environment. The simulated audio signal is a simulation of the sound environment.

The auxiliary sound processor may comprise one or more general-purpose digital processor of the auxiliary device, e.g. a CPU or GPU, that may be configured to perform other computer-implemented tasks not related to sound processing such as running a computer operating system. The auxiliary sound processor may be a specialized digital processor of the auxiliary device, e.g. a co-processor, that may be configured to perform other specialized tasks such as only sound processing.

The hearing aid system may comprise an auxiliary device. The auxiliary device may comprise the auxiliary sound processor. The auxiliary device may be configured to provide the simulated audio signal based on the listening difficulty indication and the audio input signal. The simulated audio signal may be determined based on the plurality of acoustic features. The simulated audio signal may be a simulation of the sound environment. In a particular embodiment, the auxiliary device is configured to provide the simulated audio signal based on the audio input signal from when the listening difficulty indication was indicative of a high listening difficulty. The simulated audio signal is based on the audio input signal. For example, the auxiliary device may be configured to receive the audio input signal wirelessly from the hearing aid. The auxiliary sound processor may be configured to determine at least one acoustic feature indicative of the sound environment. The auxiliary sound processor may be configured to provide the simulated audio signal based on the at least one acoustic feature.

The simulated audio signal may be an artificially generated audio signal. The simulated audio signal may be a mixed signal comprising a desired signal and a noise signal. Said mixed signal may not be an audio signal recorded in the real-world. However, the desired signal and/or the noise signal may be audio signals recorded in the real-world, but the combination of them to provide the mixed signal may be artificial. The desired signal may be artificially generated for example with the use of a speech synthesizer. The noise signal may be artificially generated by the use of a noise generator, e.g., a white noise or coloured noise generator. The desired signal may be a speech signal recorded from the real-world. The desired signal may be an artificially generated speech signal based on a recorded speech signal from the real-world for example by data augmenting the recorded speech signal. The noise signal may be artificially generated based on real-world recordings. For example, the noise signal may be a data augmented noise signal. Data augmenting of the speech signal and/or the noise signal may be understood as changing certain characteristics of the signal for example (but not limited to), changing the pitch, frequency shifting, adding coloured randomized noise, segmentation, etc. The artificially generated desired signal and/or noise signal may be generated with a trained generative artificial intelligence (generative AI) algorithm.

The simulated audio signal may comprise an artificially generated speech signal that resembles the speech signal constituting the audio input signal. For example, the artificially generated speech signal may share a similar voice characteristic of the person who articulated the speech signal constituting the audio input signal. The auxiliary sound processor may comprise a generative AI algorithm configured to generate the artificially generated speech signal. The generative AI may be trained on a dataset comprising a plurality of speech signals with corresponding acoustic features.

The generative AI may comprise a conditional Generative Adversarial Network (cGAN). The input of the cGAN may be the plurality of acoustic features determined by an acoustic feature extractor. The output of the cGAN may be simulated audio signal. The cGAN may comprise a network architecture comprising a generator and a discriminator.

The generator may comprise a first deep neural network (DNN) configured to receive the acoustic features and provide the simulated audio signal. The first deep neural network may comprise a fully connected layer comprising a plurality of fully connected layer weights. The fully connected layer may be configured to receive the acoustic features and provide a fully connected layer output signal based on the fully connected layer weights. The fully connected layer may at the output comprise an activation function. The activation function may for example be a sigmoid function, a hyperbolic tangent function, a rectified linear unit (ReLU), a softmax, a linear function, etc. The first deep neural network may comprise at least one convolutional layer such as a 1D convolutional neural networks. Each 1D convolutional neural network layer may comprise at least one convolutional filter each comprising a plurality of convolutional filter weights. The at least one convolutional layer may receive the fully connected layer output signal and provide the convolutional layer output signal based on the at least one 1D convolutional layer and the convolutional filter weights. Each convolutional layer may comprise an activation function. The first deep neural network may comprise an output layer comprising a plurality of output layer weights and an output activation function. The output layer may receive the convolutional layer output signal. The output layer weights and the output activation function may be used to map the convolutional layer output signal to a value between −1 and 1. The output activation may therefore be a hyperbolic tangent function, a generalized logistic function, etc. Alternatively, the output activation may be a linear function to map the convolutional layer output signal to an unbounded value. The output layer may be configured to receive the convolutional layer output signal and provide the simulated audio signal based on the output layer weights and the output activation function.

The second deep neural network may comprise at least one convolutional layer such as 1D convolutional neural networks. Each 1D convolutional neural network layer may comprise at least one convolutional filter each comprising a plurality of convolutional filter weights and activation function. The at least one convolutional layer may receive the acoustic features and an input audio signal. The input audio signal may be the simulated audio input or a real-world audio signal (such as the audio input signal). The at least one convolution layer may be configured to provide a discriminator value based on the at least one convolution layers. The discriminator value may be indicative of if the input audio signal is a simulated audio signal or a real-world signal while also conditioned on the acoustic features.

In a particular embodiment, the generative AI may comprise a cGAN comprising only a trained generator configured to provide the simulated audio signal. The trained generator may be trained on a second cGAN comprising a generator and a discriminator.

The generative AI may be a trained cGAN. A trained cGAN may be understood as a cGAN wherein all the weights constituting the cGAN have been modified to seek minimizing or maximizing a generative adversarial network (GAN) cost function. An untrained cGAN may therefore comprise random weights or pre-trained weights such that the untrained cGAN does not perform as good as the trained cGAN in terms of the GAN cost function. The GAN cost function may comprise a first cost function and a second cost function. The first cost function may be used for training the generator and the second cost function may be used for training the discriminator. The first cost function may be a reconstruction cost function such as the Mean Squared Error (MSE) between the provided simulated audio signal the generator and the real-world audio signal which the generator during training seek to reconstruct based on the acoustic features. The first cost function may be a classification cost function such as the binary cross entropy, which may be used to penalize the generator in dependence of the output of the discriminator. For example, if the discriminator classifies the simulated audio signal to be a real-world audio signal, the generator is not penalized and the weights are not adjusted. Otherwise, if the discriminator classifies the simulated audio signal to be a simulated audio signal, the generator is penalized to adjusts its weights. Hence, one objective of the reconstruction cost function is to encourage generation of a simulated audio signal to resemble a real-world audio signal as good as possible. The second cost function may comprise a classification cost function such as the binary cross entropy to encourage discrimination by the discriminator between the simulated audio signals (‘fake’ signals) as provided by the generator and real-world audio signals. The discriminator may output a value between ‘0’ and ‘1’, wherein a value of ‘0’ may be indicative of a ‘fake’ signal (i.e. a simulated audio signal) and a value of ‘1’ may be indicative of a real-world audio signal. Hence, one objective of the discriminator is to encourage the discriminator to correctly classify whether the input audio signal is a real-world audio signal or a simulated audio signal.

A method for training the cGAN may comprise a training set. The training set may comprise a plurality of paired samples comprising a target audio signal and its corresponding acoustic features. The target audio signal may be a real-world audio signal collected in the real-world with a microphone.

A method for training the cGAN may comprise an optimizer used to update the weights of the cGAN based on the GAN cost function, such as the Adam optimizer with a learning rate that may be adjustment during training (e.g., the learning rate may be 0.0002 and adjusted to 0.0001 later during training).

A method for training the cGAN may comprise a stopping criterion, wherein the stopping criterion may be based on monitoring the output of the GAN cost function over time. For example, monitoring the output of the GAN cost function over time may reveal performance stability or convergence. The stopping criterion may be based on monitoring the quality of the output of the generator, so that when the quality is above a pre-determined threshold, the stopping criterion is met. When the stopping criterion is met, the trained may be halted, and the optimized weights may be used for the trained cGAN.

The plurality of acoustic feature of an audio input signal may be an extracted parameter from the audio input signal indicative of acoustic characteristics of the sound environment. An acoustic characteristic of a sound environment may be understood as a characteristic related to voice, noise, or spatiality. For example, the voice characteristic may include a fundamental frequency, a pitch, loudness, phonation, rate, etc. For example, the noise characteristic may include pitch, modulation, spectral shape, loudness, signal-to-noise ratio etc. For example, the spatial characteristics may include localization, time-delay, acoustic transfer function, reverberation time, etc. of the desired signal and/or the noise signal.

A simulation of the sound environment may be the simulated audio signal. The simulated audio signal may be understood as an artificially generated audio signal which closely resembles the sound environment in terms of some acoustic characteristics. For example, the simulated audio signal may comprise a noise signal which has the same long-term spectral shape and loudness, but may differ in other aspects of the acoustic characteristics such as short-term spectral shape.

The hearing aid system may comprise a camera system configured to capture image or video of the sound environment and provide a visual input signal. The visual input signal may comprise a desired part and a noise part. The desired part of the visual input signal may comprise the image or video of the person articulating the corresponding desired (sound) signal in the audio input signal. The noise part of the visual input signal may comprise the image or video of the background or objects generating the correspond noise (sound) signal in the audio input signal.

The camera system may be configured to receive the listening difficulty indication by the user interface. The camera system may be configured to only capture image or video of the sound environment, when the listening difficulty indication is indicative of a high listening difficulty. The camera system and the auxiliary device may be configured to communicate. In a particular embodiment, the auxiliary device comprises the camera system. In another particular embodiment, a camera device comprises the camera system, and wherein the camera device and the auxiliary device are configured to wirelessly communicate. The auxiliary sound processor may be configured to receive the visual input signal or a processed version of the visual input signal and provide a simulated visual signal such as an artificially generated image or artificially generated video resembling a similar challenging listening environment. The auxiliary sound processor may be configured to receive the audio input signal and the visual input signal and provide a simulated audiovisual signal resembling a similar challenging listening environment which were indicated to be of high listening difficulty. The auxiliary device may comprise a screen. The screen may be configured to provide a visual stimulus based on the simulated visual signal. The visual stimulus may be an image or a video displayed by the screen and seen by the hearing aid user. In a particular embodiment, the simulated audiovisual signal comprises a simulated audio part and a simulated visual part. The simulated audio part is wirelessly transmitted to the hearing aid. The output unit provides an auditory output sound based on the received simulated audio part in synchronization with the visual part being displayed on the screen of the auxiliary device.

The hearing aid system comprises a hearing aid processor configured to provide a processed signal based on the simulated audio signal. The hearing aid system may comprise a hearing aid comprising a hearing aid processor. The hearing aid processor may be configured to receive the simulated audio signal and further process the simulated audio signal to provide the processed signal. The processed signal may for example be an amplification of the simulated audio signal. The amplification of the simulated audio signal may be determined in dependence with the hearing aid user's audiogram.

The hearing aid system comprises an output unit configured to provide an auditory output signal based on the processed signal. The hearing aid system may comprise a hearing aid comprising an output unit. The output unit may comprise an output transducer configured to provide an auditory output signal based on the processed signal. The output transducer may be a loudspeaker such as a hearing aid receiver. The auditory output signal may be a sound being heard by the hearing aid user.

Alternatively, the hearing aid system may comprise an auxiliary device comprising the output unit. The output unit may comprise an output transducer, e.g., a loudspeaker, configured to provide an auditory output signal based on the processed signal. The auditory output signal may be a sound being heard by the hearing aid user.

Alternatively, the hearing aid system may comprise a second auxiliary device comprising the output unit. The second auxiliary device may be a sound system comprising at least one output transducer, e.g., at least one loudspeaker. A second auxiliary device may, for example, comprise headphones, loudspeaker systems, television, or other multimedia system comprising the at least one loudspeaker.

The hearing aid system may comprise a speech enhancement system. The speech enhancement system may be configured to receive the audio input signal and attenuate the noise signal. The noise signal may constitute the audio input signal. The speech enhancement system may be configured to provide an enhanced speech signal based on a plurality of speech enhancement parameters and the audio input signal. The speech enhancement parameters may be determined based on the audio input signal. The one or more of the acoustic features determined by auxiliary sound processed may be based on the determined speech enhancement parameters.

The hearing aid system may comprise a hearing aid comprising the speech enhancement system. The speech enhancement system may be regarded as a sound processing system configured to provide an enhanced speech signal based on the audio input signal and a plurality of speech enhancement parameters. For example, the speech enhancement system may comprise a filter comprising a plurality of filter coefficients. The filter coefficients may constitute the plurality of speech enhancement parameters. The speech enhancement system may be configured to attenuate the noise signal constituting the audio input signal by applying the filter coefficients on the audio input signal by a filtering process. The filtering process may be a multiplication across frequency band if the audio input signal is represented in the time-frequency domain. The filtering process may be based on a convolution if the audio input signal is represented in discrete time-domain. The enhanced speech signal may have a higher signal-to-noise ratio compared to the audio input signal. The enhanced speech signal may have a higher speech intelligibility compared to the audio input signal.

A speech enhancement parameter may be a parameter determined based on an acoustic characteristic. The speech enhancement parameter may be a voice activity detection value determined by a voice activity detector constituting the speech enhancement system. The speech enhancement parameter may be a pitch of a speech signal constituting the audio input signal determined by spectrum analyzer or fundamental frequency analyzer. The speech enhancement parameter may be an estimated noise spectrum of the noise signal. The speech enhancement parameter may be an estimated noise field indicative of the spatial distribution of noise sources in the sound environment. The speech enhancement parameter may be an estimated signal-to-noise ratio of the sound environment.

In a particular embodiment, one or more of the acoustic features are based on the speech enhancement parameters. For example, an acoustic feature may be based on an estimated noise spectrum of the noise signal.

The hearing aid system may comprise a personalization database. The personalization database may comprise a plurality of personalization parameters. In the present disclosure, the term personalization signal, personalization data, and personalization parameter may be used interchangeably. The personalization parameters may be indicative of a user's characteristics. The auxiliary sound processor may be configured to provide the simulated audio signal based on the listening difficulty indication and the audio input signal and personalization parameters.

The auxiliary device may comprise the personalization database. The personalization database may comprise personalization parameters stored on a storage medium on the auxiliary device wherein the storage medium is a means of storing any aspects related to signals, data, parameter, or values, etc. on the auxiliary device. A personalization parameter may be indicative of the user's characteristics. The user's characteristics may be related to the hearing of the hearing aid user. The user's characteristics may be an audiogram, or an pinnae-related transfer function representing the pinnae acoustics of the hearing aid user, the head-related transfer function of the hearing aid user, the voice characteristics of the hearing aid user, etc. The user's characteristics may be related to the hearing aid user's physique such as the hearing aid user's height, age, weight, etc.

The auxiliary device may be wirelessly interfaced with a cloud server storage comprising the personalization database. The auxiliary device may receive personalization parameters stored on the cloud server storage.

In a particular embodiment, the auxiliary sound processor is configured to provide the simulated audio signal based on the audio input signal and at least one personalization parameter when the listening difficulty indication is high. A personalization parameter may for example be the pinnae-related transfer function. The auxiliary sound processor may be configured to first provide a simulated desired audio signal, such as a desired speech signal. The simulated desired audio signal may then be processed using the pinnae-related transfer function to obtain a simulated desired audio signal at heard at the pinnae by the hearing aid user by filtering the simulated desired audio signal with the pinnae-related transfer function. In another example, personalization parameter may for example be the head-related transfer function. The auxiliary sound processor may be configured to combine the simulated desired audio signal and simulated noise audio signal to provide the simulated audio signal.

The hearing aid system may be configured to operate in a normal mode of operation and a practice mode of operation. The hearing aid system may in the normal mode of operation be configured to provide the processed signal based on the enhanced speech signal. The hearing aid system may in the practice mode of operation be configured to provide the processed signal based on the simulated audio signal.

The hearing aid system may be configured to operate in a normal mode of operation when the listening difficulty indication is indicative of a low listening difficulty. In the normal mode of operation, the hearing aid may be configured to provide the auditory output sound based on the enhanced speech signal determined based on the audio input signal. In the normal mode of operation, the hearing aid provides typical speech enhancement (or noise reduction), hearing loss compensation, and acoustic feedback cancellation.

The hearing aid system may be configured to operate in a practice mode of operation. The practice mode of operation may be triggered by the hearing aid user through a user input panel constituting the auxiliary device. The hearing aid may in the practice mode of operation provide the auditory output sound based on the simulated audio signal only. In a particular embodiment, the hearing aid may in the practice mode of operation provide the auditory output sound based on a combination between the simulated audio signal and the enhanced speech signal.

The hearing aid system may be configured to operate in a recording mode of operation. The hearing aid system may in the recording mode of operation be configured store the plurality of acoustic features in a memory unit. The memory unit may be configured to provide a plurality of stored acoustic features.

The hearing aid system may be configured to operate in a recording mode of operation. The recording mode of operation may be triggered when the listening difficulty indication is indicative of a high listening difficulty. In the recording mode, the hearing aid system may be configured to record, i.e. store, the audio input signal or acoustic characteristics determined based on the audio input signal. The hearing aid or the auxiliary device may be configured to store the audio input signal or the acoustic features. The hearing aid system may comprise a memory unit configured to store the audio input signal or the acoustic features. The simulated audio signal may be provided based on the stored audio input signal or the stored acoustic features.

In a particular embodiment, the auxiliary device comprises the memory unit configured to store a plurality of acoustic features determined based on the audio input signal.

The hearing aid system may be configured to enter the recording mode of operation from the normal mode of operation. The hearing aid system may be configured to enter the practice mode of operation or the normal mode of operation while in the recording mode of operation or after the recording mode of operation.

The hearing aid system may in the practice mode of operation be configured to provide the simulated audio signal based on the listening difficulty indication and the plurality of stored acoustic features.

The auxiliary device may in the practice mode of operation be configured to provide the simulated audio signal based on the plurality of acoustic features from when the listening difficulty indication was indicative of a high listening difficulty.

The hearing aid system may in the practice mode of operation be configured to provide the simulated audio signal based on the listening difficulty indication, and the plurality of stored acoustic features, and the personalization parameters.

The hearing aid system may be configured to select the mode of operation based on the listening difficulty indication.

The hearing aid system may be configured to return to the normal mode of operation from the recoding mode of operation after a pre-determined condition. The pre-determined condition may be based on a timer. The timer may be configured to save a first timestamp indicative of the time wherein the hearing aid system entered the recording mode of operation. The timer may be configured measure time and exit the recording mode of operation and return to the normal mode of operation when the measured time has exceeded a pre-determined timer threshold.

The pre-determined condition may be based on the determined acoustic features. The hearing aid system may comprise a quality controller configured to determine the quality of the acoustic features, such that when the determined quality of the acoustic features is above a quality threshold, then the hearing aid system may exit the recording mode of operation, and store the acoustic features in the memory unit.

The hearing aid system may comprise a user input panel. The user input panel may be configured to receive a user input by the user. The user input panel may be configured to select the mode of operation based on the listening difficulty indication and/or the user input.

The user input panel may be a software interface displayed on a screen on the auxiliary device. The hearing aid user may use the user input panel to indicate a desired mode of operation and wherein the indication may be based on the user's interaction with the user input panel. For example, the hearing aid user may use the user input panel to indicate that the user may want to select the practice mode of operation or the recording mode of operation or the normal mode of operation.

The hearing aid system may be configured to select the normal mode of operation or the recording mode of operation based on the listening difficulty indication, and wherein the hearing aid system may be configured to select the normal mode of operation if the listening difficulty indication is indicative of a low listening difficulty, and wherein the hearing aid system may be configured to select the recording mode of operation if the listening difficulty indication is indicative of a high listening difficulty.

The hearing aid system may be configured to select the practice mode of operation or a non-practice mode of operation based on the user input, and wherein if the practice mode of operation is selected, the hearing aid system only operates in the practice mode of operation until the non-practice mode of operation is selected based on the user input, and wherein the hearing aid system in the non-practice mode of operation further operates in the normal mode of operation or the recording mode of operation.

In the practice mode, the auditory output signal may be based on the simulated audio signal. In the non-practice, the auditory output signal may be based on the audio input signal only.

The hearing aid system may in the practice mode of operation be configured to present the auditory output signal as sound for the user. The user input panel may in the practice mode of operation be configured to receive a user feedback indicative of the user's listening difficulty based on the presented auditory output signal.

The hearing aid system may in the practice mode of operation be configured to store the user performance. The hearing aid system may be configured to determine one or more of the speech enhancement parameters based on the user performance score. For example, the degree of noise suppression determined by the speech enhancement parameters may be determined based on the user performance score such that if the user performance score is low, e.g. due to poor speech understanding, a higher degree of noise suppression will be applied than if the user performance score is high.

The hearing aid system may comprise an error model. The error model may be configured to determine a user performance score based on the user feedback and an expected feedback. The auxiliary sound processor may be configured to receive the user performance score. The auxiliary sound processor may in the practice mode of operation be configured to provide a modified simulated audio signal based on the user performance score. The hearing aid system may be configured to be in a continued use of the practice mode of operation and provide the auditory output signal based on the modified simulated audio signal. The auxiliary sound processor may in the continued use of the practice mode of operation be configured to provide a plurality of different modified simulated audio signals.

In a particular embodiment, the auxiliary sound processor is configured to provide the simulated audio signal in the practice mode of operation. The auditory output signal being based on the simulated audio signal. The hearing aid user may provide a user feedback based on the heard auditory output signal. For example, the hearing aid user may provide the user feedback as a rating on perceived speech understanding for a subjective user performance score. In another example, the hearing aid user may provide an estimate (or a guess) of the heard speech in the simulated audio signal. The estimate may be provided as a spoken sentence by the hearing aid user or a text input by the hearing aid user through the user input panel.

The error model may be an algorithm configured to determine the user performance score based on the user feedback and an expected feedback. The user feedback may be an objective evaluation. In a particular embodiment, the simulated audio signal comprises a speech signal with a known or pre-determined sentence being the expected feedback. The hearing aid user may provide an estimate of the sentence through the user input panel as the user feedback. The error model may be configured to compare the estimate of the sentence (i.e. the user feedback) and the known or pre-determined sentence (i.e. the expected feedback) and determine the user performance score. For example, the error model may compare word-by-word on the accuracy of detected correct words by the hearing aid user. For example, the error model may be based on morpheme level. The morpheme level may be used to obtain a more accurate estimate of the hearing aid user's struggles compared to a word-by-word comparison, since the word-by-word error model may not detect which particular part of speech that the hearing aid user struggles with. The morpheme level may break down each individual estimated word by the hearing aid user down to morphemes, i.e., the smallest constituents within a word. The error model may be configured to compare the estimate of the morphemes (i.e. the user feedback) and a known or pre-determined morphemes (i.e. the expected feedback) and determine the user performance score. Thereby, the error model may provide a user performance score with more detailed insights that can detect particular struggles on a morpheme level such as cat (user feedback) instead of cap (expected feedback), bread (user feedback) instead of thread (expected feedback, pool (user feedback) instead of cool (expected feedback).

The user feedback may be a subjective evaluation such as perceived listening difficulty including a perceived listening effort, a perceived cognitive load, a perceived listening difficulty, a perceived noise level, etc. The subjective evaluation may be a self-reported value spanning from a minimum level (e.g. a value of ‘0’) indicative of least perceived listening difficulty to a maximum level (e.g. a value of ‘10’) indicative of most perceived listening difficulty.

The error model may determine the user performance score based on the objective evaluation and the subjective evaluation. The user performance score may be determined based on a combination, e.g., linear combination, of the objective evaluation and the subjective evaluation using a pre-determined weight.

The auxiliary sound processor may be configured to modify the plurality of speech enhancement parameters based on the user feedback. The auxiliary sound processor may be configured to modify the plurality of speech enhancement parameters when the hearing aid system switches from the practice mode of operation to the normal mode of operation.

In a particular embodiment, the hearing aid user may select the practice mode of operation to engage in a practice session where the hearing aid user may practice on simulated audio signals to try improving speech perception. The hearing aid user may after the practice session decide to exit the practice mode of operation by selecting the normal mode of operation through the user interface or the user input panel. When the hearing aid system switches from the practice mode of operation to the normal mode of operation the hearing aid system may use one or more performance scores stored during the practice mode of operation and determine one or more speech enhancement parameters. The speech enhancement parameters may be used by the speech enhancement system.

In a particular embodiment, the hearing aid system comprises a hearing aid comprising a speech enhancement system and an auxiliary device. The speech enhancement parameters are determined based on the user performance score and may be determined by the auxiliary device. The determined speech enhancement parameters are transmitted to the hearing aid for use in the hearing aid's speech enhancement system.

In a particular embodiment, the hearing aid system comprises a hearing aid comprising a speech enhancement system and an auxiliary device. The speech enhancement parameters are determined based on the user performance score and a user preference and may be determined by the auxiliary device. The determined speech enhancement parameters are transmitted to the hearing aid for use in the hearing aid's speech enhancement system. The user preference may be a set of speech enhancement parameters which the hearing aid user prefer. The user performance score and the user preference may be used to determine the speech enhancement parameters based on a combination, such as a linear combination using a pre-defined or user determined weight.

The auxiliary sound processor may comprise a generative audio model. The generative audio model may be configured to determine the simulated audio signal based on the the audio input signal and the plurality of personalization parameters of the personalization database.

The generative audio model may comprise an acoustic model configured to provide the simulated audio signal. The acoustic model may comprise an audio database comprising a plurality of speech signals and noise signals. The acoustic model may comprise a plurality of mixture signal wherein each mixture signal comprises a combination of a speech signal and a noise signal. The generative audio model may in a particular embodiment be configured to select a mixture signal based on the determined acoustic features. For example, the generative audio model may select a mixture signal with similar signal-to-noise ratio, voice characteristics, noise characteristics as the indicated by the determined acoustic features. The generative audio model may in a particular embodiment be configured to provide a mixture signal (being the simulated audio signal) by mixing a selected speech signal of the audio database and a selected noise signal of the database. The selected speech signal may be determined based on selecting a speech signal from the audio database with a similar voice characteristics as indicated in the determined acoustic features. The selected noise signal may be determined based on selecting a noise signal from the audio database with a similar noise characteristics as indicated in the determined acoustic features. The mixing may comprise a mixing weight, and wherein the mixing weight may be determined based on the acoustic features such as a determined signal-to-noise ratio.

The generative audio model may comprise a deep learning model. The deep learning model may comprise a plurality of deep learning model weights. The deep learning model may be configured to provide the simulated audio signal based on the plurality of acoustic features and deep learning model weights. The deep learning model weights may be determined according to a method of training the deep learning model.

In a particular embodiment, the deep learning model is a deep neural network comprising a plurality of layers. Each layer comprises a plurality of deep learning model weights. Each layer uses a part of the deep learning model weights to provide an intermediate output used by the next a next layer constituting the plurality of layers. Each layer comprises an activation function such as the sigmoid function, the softmax function, ReLU function, or a linear function.

The plurality of deep learning model weights may be determined during offline training of the deep learning model. The offline training may comprise a training set comprising acoustic features and a target audio signal. The deep learning model weights may be determined based on optimizing the deep learning model weights such that output of the deep learning model minimizes a pre-determined cost function indicative of a difference between target audio signal and the output of the deep learning model. The difference may be based mean-squared error and cross entropy as examples.

The hearing aid system may comprise an audio database comprising a plurality of audio components. The auxiliary sound processor may be configured to select a plurality of audio components of the audio database based on the acoustic features. The generative audio model may be configured to provide the simulated audio signal based on combining the selected audio components.

The plurality of audio components may be a plurality of segments of audio signal including speech signals and noise signals.

The hearing aid system may comprise a hearing aid and an auxiliary device. The hearing aid may comprise the input unit, the hearing aid processor, the speech enhancement system, the user interface, and the output unit. The auxiliary device may comprise, the personalization database, and the auxiliary sound processor.

The hearing aid and the auxiliary device may be configured to wirelessly communicate. The auxiliary device may be configured to wirelessly receive the acoustic features and/or the audio input signal and/or the listening difficulty indication from the hearing aid. The hearing aid may be configured to wirelessly receive the simulated audio signal and/or the speech enhancement parameters from the auxiliary device.

The user interface of the hearing aid may comprise a physical button or speech recognition system.

The hearing aid system may comprise a hearing aid and an auxiliary device. The hearing aid comprises the input unit, the hearing aid processor, the speech enhancement system, and the output unit. The auxiliary device may comprise, the personalization database, the user interface, and the auxiliary sound processor. The user interface of the auxiliary may for example comprise a virtual button, virtual slider, a virtual keyboard for providing a text input on a touch screen, or speech recognition system.

The user interface may comprise a user interface sensor configured to determine a physical interaction of the user on the user interface. The physical interaction may be indicative of the listening difficulty. The user interface may be configured to provide the listening difficulty indication based on the physical interaction.

The user interface sensor may be a force sensor or a pressure sensor. The user interface may be resistive button comprising a resistor which may change its resistance based on if the button is pressed or not. The physical interaction may be when the hearing aid user presses the button.

The user interface may be configured to receive the audio input signal. The user interface may comprise a speech recognition system configured to determine the listening difficulty indication based on the audio input signal.

The user interface (UI) may comprise a body-mounted sensor. The body-mounted sensor may be configured to provide the listening difficulty indication (102) based on a measured fatigue level or cognitive load by the body-mounted sensor.

The body-mounted sensor may comprise an EEG or EOG sensor. The EEG sensor may be configured to be mounted on the hearing aid user to measure EEG signals or EOG signals. The EEG or EOG sensor may be configured to pick-up EOG or EOG signals of the hearing aid user. The body-mounted sensor may comprise a movement sensor such as an accelerometer. The accelerometer may be configured to be mounted on the hearing aid user to measure movements. The body-mounted sensor may be configured to measure a heart-rate of the user indicative of a fatigue level or a cognitive load.

The hearing aid system may comprise a binaural hearing aid. The binaural hearing aid may comprise two hearing aids and the auxiliary device. The two hearing aids may be configured to wirelessly communicate.

In a particular embodiment, one of the two hearing aids act as a master communication device and the other as a slave communication device. The master communication device may be configured to wirelessly communicate with the auxiliary device. The master communication device may be configured to receive the simulated audio signal and/or the speech enhancement parameters from the auxiliary device. The master communication device may be configured to transmit the received simulated audio signal and/or the speech enhancement parameters to the slave communication device.

The input unit may comprise a plurality of input transducers, such as microphones, each configured to provide an audio input signal. The speech enhancement system may in the normal mode of operation be configured to provide the enhanced speech signal based on the plurality of audio input signals. The hearing aid system may be configured to determine the plurality of acoustic features based on the plurality of audio input signals. The speech enhancement system may be configured to determine one or more of the plurality of acoustic features based on the plurality of audio input signals.

The hearing aid system may be configured to store the user performance score. The user performance score may be accessed by a hearing care professional. The hearing care professional may use the user performance score to determine at least one the speech enhancement parameter.

The hearing aid system may be adapted to establish a communication link between the hearing aid and the auxiliary device to provide that information (e.g. control and status signals, possibly audio signals) can be exchanged or forwarded from one to the other.

The auxiliary device may be constituted by or comprise a remote control, a smartphone, or other portable or wearable electronic device, such as a smartwatch or the like.

The auxiliary device may be constituted by or comprise a remote control for controlling functionality and operation of the hearing aid(s). The functionalities of a remote control may be implemented in a smartphone, the smartphone possibly running an APP allowing to control the functionality of the audio processing device via the smartphone (the hearing aid(s) comprising an appropriate wireless interface to the smartphone, e.g. based on Bluetooth or some other standardized or proprietary scheme).

The auxiliary device may be constituted by or comprise an audio gateway device adapted for receiving a multitude of audio signals (e.g. from an entertainment device, e.g. a TV or a music player, a telephone apparatus, e.g. a mobile telephone or a computer, e.g. a PC, a wireless microphone, etc.) and adapted for selecting and/or combining an appropriate one of the received audio signals (or combination of signals) for transmission to the hearing aid.

The auxiliary device may be constituted by or comprise another hearing aid. The hearing aid system may comprise two hearing aids adapted to implement a binaural hearing aid system, e.g. a binaural hearing aid system.

### A Second Hearing Aid System

In a second aspect, a hearing aid system comprises an input unit. The input unit comprises an input transducer. The input transducer is configured to provide an audio input signal indicative of sound of a sound environment.

The hearing aid system comprises an auxiliary sound processor. The auxiliary sound processor is configured to determine a plurality of hearing aid settings based on a user performance score. The user performance score is determined based on a user feedback. The user feedback is determined during a user training session wherein a plurality of simulated audio signals is presented to the user. The user provides the of user feedback based on the presented simulated audio signals.

The hearing aid system comprises a hearing aid processor configured to provide a processed signal based on the hearing aid settings and the audio input signal.

The hearing aid system comprises an output unit configured to provide an auditory output signal based on the processed signal.

The hearing aid system may comprise a user input panel configured to provide a user feedback based on an interaction with a user. The user feedback may be indicative of the hearing aid user's listening difficulty based on the simulated audio signal.

### A Third Hearing Aid System

In a third aspect, a hearing aid system comprises an input unit. The input unit comprises an input transducer. The input transducer is configured to provide an audio input signal indicative of sound of a sound environment.

The hearing aid system comprises a user interface. The user interface is configured to provide a listening difficulty indication based on an interaction with a user. The listening difficulty indication is indicative of the user's listening difficulty in the sound environment. The user interface may comprise a user input panel configured to receive a user input by the user. The user interface may be configured to provide a listening difficulty indication based the user input.

The hearing aid system comprises a camera system. The camera system comprises a visual sensor and camera processor. The visual sensor is configured to capture video and provide a visual signal. The camera processor is configured to determine at least one visual feature from the visual signal. The visual feature is indicative of at least one sound object in the sound environment.

The hearing aid system comprises an auxiliary sound processor. The auxiliary sound processor is configured to provide a simulated audio signal based on the listening difficulty indication and a plurality of acoustic features. The auxiliary sound processor is configured to determine the plurality of acoustic features based on the audio input signal. Each of the plurality of acoustic features is indicative of an acoustic characteristic of the sound environment. The simulated audio signal is a simulation of the sound environment.

The hearing aid system comprises a hearing aid processor configured to provide a processed signal based on the simulated audio signal.

The hearing aid system comprises an output unit configured to provide an auditory output signal based on the processed signal.

The auxiliary sound processor may be configured to provide a simulated audio signal, and a simulated visual signal based on the acoustic features. The simulated visual signal may comprise visual objects corresponding to visual objects as present in the sound environment. The hearing aid system may comprise an auxiliary device comprising a screen configured to provide a visual stimulus based on the simulated visual signal. The visual stimulus being seen by the hearing aid user. A simulated visual signal may be an artificially generated video of a simulated sound environment resembling the sound environment.

### A Hearing Aid

The hearing aid may be adapted to provide a frequency dependent gain and/or a level dependent compression and/or a transposition (with or without frequency compression) of one or more frequency ranges to one or more other frequency ranges, e.g. to compensate for a hearing impairment of a user. The hearing aid may comprise a hearing aid processor for enhancing the input signals and providing a processed output signal.

The hearing aid may comprise an output unit for providing a stimulus perceived by the user as an acoustic signal based on a processed electric signal. The output unit may a vibrator of a bone conducting hearing aid. The output unit may comprise an output transducer. The output transducer may comprise a receiver (loudspeaker) for providing the stimulus as an acoustic signal to the user (e.g. in an acoustic (air conduction based) hearing aid). The output transducer may comprise a vibrator for providing the stimulus as mechanical vibration of a skull bone to the user (e.g. in a bone-attached or bone-anchored hearing aid). The output unit may (additionally or alternatively) comprise a (e.g. wireless) transmitter for transmitting sound picked up-by the hearing aid to another device, e.g. a far-end communication partner (e.g. via a network, e.g. in a telephone mode of operation, or in a headset configuration).

The hearing aid may comprise an input unit for providing an electric input signal representing sound. The input unit may comprise an input transducer, e.g. a microphone, for converting an input sound to an electric input signal. The input unit may comprise a wireless receiver for receiving a wireless signal comprising or representing sound and for providing an electric input signal representing said sound.

The wireless receiver and/or transmitter may e.g. be configured to receive and/or transmit an electromagnetic signal in the radio frequency range (3 kHz to 300 GHz). The wireless receiver and/or transmitter may e.g. be configured to receive and/or transmit an electromagnetic signal in a frequency range of light (e.g. infrared light 300 GHz to 430 THz, or visible light, e.g. 430 THz to 770 THz).

The hearing aid may comprise a directional microphone system adapted to spatially filter sounds from the environment, and thereby enhance a target acoustic source among a multitude of acoustic sources in the local environment of the user wearing the hearing aid. The directional system may be adapted to detect (such as adaptively detect) from which direction a particular part of the microphone signal originates. This can be achieved in various different ways as e.g. described in the prior art. In hearing aids, a microphone array beamformer is often used for spatially attenuating background noise sources. The beamformer may comprise a linear constraint minimum variance (LCMV) beamformer. Many beamformer variants can be found in literature. The minimum variance distortion-less response (MVDR) beamformer is widely used in microphone array signal processing. Ideally the MVDR beamformer keeps the signals from the target direction (also referred to as the look direction) unchanged, while attenuating sound signals from other directions maximally. The generalized sidelobe canceller (GSC) structure is an equivalent representation of the MVDR beamformer offering computational and numerical advantages over a direct implementation in its original form.

Most sound signal sources (except the user's own voice) are located far way from the user compared to dimensions of the hearing aid, e.g. a distance d_{mic} between two microphones of a directional system. A typical microphone distance in a hearing aid is of the order 10 mm. A minimum distance of a sound source of interest to the user (e.g. sound from the user's mouth or sound from an audio delivery device) is of the order of 0.1 m (>10 d_{mic}). For such minimum distances, the hearing aid (microphones) would be in the acoustic near-field of the sound source and a difference in level of the sound signals impinging on respective microphones may be significant. A typical distance for a communication partner is more than 1 m (>100 d_{mic}). The hearing aid (microphones) would be in the acoustic far-field of the sound source and a difference in level of the sound signals impinging on respective microphones is insignificant. The difference in time of arrival of sound impinging in the direction of the microphone axis (e.g. the front or back of a normal hearing aid) is ΔT=d_{mic}/v_{sound}=0.01/343 [s]=29 μs, where v_{sound} is the speed of sound in air at 20° C. (343 m/s).

The hearing aid may comprise antenna and transceiver circuitry allowing a wireless link to an entertainment device (e.g. a TV-set), a communication device (e.g. a telephone), a wireless microphone, a separate (external) processing device, or another hearing aid, etc. The hearing aid may thus be configured to wirelessly receive a direct electric input signal from another device. Likewise, the hearing aid may be configured to wirelessly transmit a direct electric output signal to another device. The direct electric input or output signal may represent or comprise an audio signal and/or a control signal and/or an information signal.

In general, a wireless link established by antenna and transceiver circuitry of the hearing aid can be of any type. The wireless link may be a link based on near-field communication, e.g. an inductive link based on an inductive coupling between antenna coils of transmitter and receiver parts. The wireless link may be based on far-field, electromagnetic radiation. Preferably, frequencies used to establish a communication link between the hearing aid and the other device is below 70 GHz, e.g. located in a range from 50 MHz to 70 GHz, e.g. above 300 MHz, e.g. in an ISM range above 300 MHz, e.g. in the 900 MHz range or in the 2.4 GHz range or in the 5.8 GHz range or in the 60 GHz range (ISM=Industrial, Scientific and Medical, such standardized ranges being e.g. defined by the International Telecommunication Union, ITU). The wireless link may be based on a standardized or proprietary technology. The wireless link may be based on Bluetooth technology (e.g. Bluetooth Low-Energy technology, e.g. LE audio), or Ultra WideBand (UWB) technology.

The hearing aid may be constituted by or form part of a portable (i.e. configured to be wearable) device, e.g. a device comprising a local energy source, e.g. a battery, e.g. a rechargeable battery. The hearing aid may e.g. be a low weight, easily wearable, device, e.g. having a total weight less than 100 g, such as less than 20 g, such as less than 5 g.

The hearing aid may comprise a ‘forward’ (or ‘signal’) path for processing an audio signal between an input and an output of the hearing aid. A signal processor may be located in the forward path. The signal processor may be adapted to provide a frequency dependent gain according to a user's particular needs (e.g. hearing impairment). The hearing aid may comprise an ‘analysis’ path comprising functional components for analyzing signals and/or controlling processing of the forward path. Some or all signal processing of the analysis path and/or the forward path may be conducted in the frequency domain, in which case the hearing aid comprises appropriate analysis and synthesis filter banks. Some or all signal processing of the analysis path and/or the forward path may be conducted in the time domain.

An analogue electric signal representing an acoustic signal may be converted to a digital audio signal in an analogue-to-digital (AD) conversion process, where the analogue signal is sampled with a predefined sampling frequency or rate fₛ, fₛ being e.g. in the range from 8 kHz to 48 kHz (adapted to the particular needs of the application) to provide digital samples xₙ (or x[n]) at discrete points in time tₙ (or n), each audio sample representing the value of the acoustic signal at tₙ by a predefined number N_{b} of bits, N_{b} being e.g. in the range from 1 to 48 bits, e.g. 24 bits. Each audio sample is hence quantized using N_{b} bits (resulting in 2^{Nb} different possible values of the audio sample). A digital sample x has a length in time of 1/fₛ, e.g. 50 μs, for fₛ=20 kHz. A number of audio samples may be arranged in a time frame. A time frame may comprise 64 or 128 audio data samples. Other frame lengths may be used depending on the practical application.

The hearing aid may comprise an analogue-to-digital (AD) converter to digitize an analogue input (e.g. from an input transducer, such as a microphone) with a predefined sampling rate, e.g. 20 kHz. The hearing aids may comprise a digital-to-analogue (DA) converter to convert a digital signal to an analogue output signal, e.g. for being presented to a user via an output transducer.

The hearing aid, e.g. the input unit, and or the antenna and transceiver circuitry may comprise a transform unit for converting a time domain signal to a signal in the transform domain (e.g. frequency domain or Laplace domain, Z transform, wavelet transform, etc.). The transform unit may be constituted by or comprise a TF-conversion unit for providing a time-frequency representation of an input signal. The time-frequency representation may comprise an array or map of corresponding complex or real values of the signal in question in a particular time and frequency range. The TF conversion unit may comprise a filter bank for filtering a (time varying) input signal and providing a number of (time varying) output signals each comprising a distinct frequency range of the input signal. The TF conversion unit may comprise a Fourier transformation unit (e.g. a Discrete Fourier Transform (DFT) algorithm, or a Short Time Fourier Transform (STFT) algorithm, or similar) for converting a time variant input signal to a (time variant) signal in the (time-)frequency domain. The frequency range considered by the hearing aid from a minimum frequency fₘᵢₙ to a maximum frequency fₘₐₓ may comprise a part of the typical human audible frequency range from 20 Hz to 20 kHz, e.g. a part of the range from 20 Hz to 12 kHz. Typically, a sample rate fₛ is larger than or equal to twice the maximum frequency fₘₐₓ, fₛ≥2 fₘₐₓ. A signal of the forward and/or analysis path of the hearing aid may be split into a number NI of frequency bands (e.g. of uniform width), where NI is e.g. larger than 5, such as larger than 10, such as larger than 50, such as larger than 100, such as larger than 500, at least some of which are processed individually. The hearing aid may be adapted to process a signal of the forward and/or analysis path in a number NP of different frequency channels (NP≤NI). The frequency channels may be uniform or non-uniform in width (e.g. increasing in width with frequency), overlapping or non-overlapping.

The hearing aid may be configured to operate in different modes, e.g. a normal mode and one or more specific modes, e.g. selectable by a user, or automatically selectable. A mode of operation may be optimized to a specific acoustic situation or environment, e.g. a communication mode, such as a telephone mode. A mode of operation may include a low-power mode, where functionality of the hearing aid is reduced (e.g. to save power), e.g. to disable wireless communication, and/or to disable specific features of the hearing aid.

The hearing aid may comprise a number of detectors configured to provide status signals relating to a current physical environment of the hearing aid (e.g. the current acoustic environment), and/or to a current state of the user wearing the hearing aid, and/or to a current state or mode of operation of the hearing aid. Alternatively or additionally, one or more detectors may form part of an external device in communication (e.g. wirelessly) with the hearing aid. An external device may e.g. comprise another hearing aid, a remote control, and audio delivery device, a telephone (e.g. a smartphone), an external sensor, etc.

One or more of the number of detectors may operate on the full band signal (time domain). One or more of the number of detectors may operate on band split signals ((time-) frequency domain), e.g. in a limited number of frequency bands.

The number of detectors may comprise a level detector for estimating a current level of a signal of the forward path. The detector may be configured to decide whether the current level of a signal of the forward path is above or below a given (L-)threshold value. The level detector operates on the full band signal (time domain). The level detector operates on band split signals ((time-) frequency domain).

The hearing aid may comprise a voice activity detector (VAD) for estimating whether or not (or with what probability) an input signal comprises a voice signal (at a given point in time). A voice signal may in the present context be taken to include a speech signal from a human being. It may also include other forms of utterances generated by the human speech system (e.g. singing). The voice activity detector unit may be adapted to classify a current acoustic environment of the user as a VOICE or NO-VOICE environment. This has the advantage that time segments of the electric microphone signal comprising human utterances (e.g. speech) in the user's environment can be identified, and thus separated from time segments only (or mainly) comprising other sound sources (e.g. artificially generated noise). The voice activity detector may be adapted to detect as a VOICE also the user's own voice. Alternatively, the voice activity detector may be adapted to exclude a user's own voice from the detection of a VOICE.

The hearing aid may comprise an own voice detector for estimating whether or not (or with what probability) a given input sound (e.g. a voice, e.g. speech) originates from the voice of the user of the system. A microphone system of the hearing aid may be adapted to be able to differentiate between a user's own voice and another person's voice and possibly from NON-voice sounds.

The number of detectors may comprise a movement detector, e.g. an acceleration sensor. The movement detector may be configured to detect movement of the user's facial muscles and/or bones, e.g. due to speech or chewing (e.g. jaw movement) and to provide a detector signal indicative thereof.

The hearing aid may comprise a classification unit configured to classify the current situation based on input signals from (at least some of) the detectors, and possibly other inputs as well. In the present context ‘a current situation’ may be taken to be defined by one or more of
a) the physical environment (e.g. including the current electromagnetic environment, e.g. the occurrence of electromagnetic signals (e.g. comprising audio and/or control signals) intended or not intended for reception by the hearing aid, or other properties of the current environment than acoustic);
b) the current acoustic situation (input level, feedback, etc.), and
c) the current mode or state of the user (movement, temperature, cognitive load, etc.);
d) the current mode or state of the hearing aid (program selected, time elapsed since last user interaction, etc.) and/or of another device in communication with the hearing aid.

The classification unit may be based on or comprise a deep learning model, e.g. a recurrent deep learning model, e.g. a trained deep learning model.

The hearing aid may comprise an acoustic (and/or mechanical) feedback control (e.g. suppression) or echo-cancelling system. Adaptive feedback cancellation has the ability to track feedback path changes over time. It is typically based on a linear time invariant filter to estimate the feedback path but its filter weights are updated over time. The filter update may be calculated using stochastic gradient algorithms, including some form of the Least Mean Square (LMS) or the Normalized LMS (NLMS) algorithms. They both have the property to minimize the error signal in the mean square sense with the NLMS additionally normalizing the filter update with respect to the squared Euclidean norm of some reference signal.

The hearing aid may further comprise other relevant functionality for the application in question, e.g. compression, noise reduction, etc.

The hearing aid may comprise a hearing instrument, e.g. a hearing instrument adapted for being located at the ear or fully or partially in the ear canal of a user, e.g. a headset, an earphone, an ear protection device or a combination thereof. A hearing aid system may comprise a speakerphone (comprising a number of input transducers (e.g. a microphone array) and a number of output transducers, e.g. one or more loudspeakers, and one or more audio (and possibly video) transmitters e.g. for use in an audio conference situation), e.g. comprising a beamformer filtering unit, e.g. providing multiple beamforming capabilities.

### A Method

In an aspect, a method for operating a hearing aid system is provided by the present application.

A method for providing an auditory output signal comprises providing, by an input unit comprising an input transducer, an audio input signal indicative of sound of a sound environment. The method further comprises providing, by a user interface comprising a user input panel for receiving a user input by the user, a listening difficulty indication based on an interaction with a user or the user input. The listening difficulty indication being indicative of the user's listening difficulty in the sound environment.

The method further comprises providing, by an auxiliary sound processor, a simulated audio signal based on the listening difficulty indication and a plurality of acoustic features each indicative of an acoustic characteristic of the sound environment. Acoustic features being determined based on the audio input signal. The simulated audio signal (103) is determined based on the plurality of acoustic features and is a simulation of the sound environment. The simulated simulated audio signal being a simulation of the sound environment.

The method further comprises providing, by a hearing aid processor, a processed signal based on the simulated audio signal. The method further comprises providing, by an output unit, an auditory output signal based on the processed signal.

It is intended that some or all of the structural features of the device described above, in the ‘detailed description of embodiments’ or in the claims can be combined with embodiments of the method, when appropriately substituted by a corresponding process and vice versa. Embodiments of the method have the same advantages as the corresponding devices.

### An App

In a further aspect, a non-transitory application, termed an APP, is furthermore provided by the present disclosure. The APP comprises executable instructions configured to be executed on an auxiliary device to implement a user interface or a user input panel for a hearing aid or a hearing aid system described above in the ‘detailed description of embodiments’, and in the claims. The APP may be configured to run on cellular phone, e.g. a smartphone, or on another portable device allowing communication with said hearing aid or said hearing aid system.

### Definitions

In the present context, a hearing aid, e.g. a hearing instrument, refers to a device, which is adapted to improve, augment and/or protect the hearing capability of a user by receiving acoustic signals from the user's surroundings, generating corresponding audio signals, possibly modifying the audio signals and providing the possibly modified audio signals as audible signals to at least one of the user's ears. Such audible signals may e.g. be provided in the form of acoustic signals radiated into the user's outer ears and/or acoustic signals transferred as mechanical vibrations to the user's inner ears through the bone structure of the user's head and/or through parts of the middle ear.

The hearing aid may be configured to be worn in any known way, e.g. as a unit arranged behind the ear with a tube leading radiated acoustic signals into the ear canal or with an output transducer, e.g. a loudspeaker, arranged close to or in the ear canal, as a unit entirely or partly arranged in the pinna and/or in the ear canal, as a unit, e.g. a vibrator, attached to a fixture implanted into the skull bone, etc. The hearing aid may comprise a single unit or several units communicating (e.g. acoustically, electrically or optically) with each other. The loudspeaker may be arranged in a housing together with other components of the hearing aid, or may be an external unit in itself (possibly in combination with a flexible guiding element, e.g. a dome-like element).

A hearing aid may be adapted to a particular user's needs, e.g. a hearing impairment. A configurable signal processing circuit of the hearing aid may be adapted to apply a frequency and level dependent compressive amplification of an input signal. A customized frequency and level dependent gain (amplification or compression) may be determined in a fitting process by a fitting system based on a user's hearing data, e.g. an audiogram, using a fitting rationale (e.g. adapted to speech). The frequency and level dependent gain may e.g. be embodied in processing parameters, e.g. uploaded to the hearing aid via an interface to a programming device (fitting system), and used by a processing algorithm executed by the configurable signal processing circuit of the hearing aid.

A ‘hearing aid system’ refers to a system comprising one or two hearing aids, and a ‘binaural hearing aid system’ refers to a system comprising two hearing aids and being adapted to cooperatively provide audible signals to both of the user's ears. Hearing aid systems or binaural hearing aid systems may further comprise one or more ‘auxiliary devices’, which communicate with the hearing aid(s) and affect and/or benefit from the function of the hearing aid(s). Such auxiliary devices may include at least one of a remote control, a remote microphone, an audio gateway device, an entertainment device, e.g. a music player, a wireless communication device, e.g. a mobile phone (such as a smartphone) or a tablet or another device, e.g. comprising a graphical interface. Hearing aids, hearing aid systems or binaural hearing aid systems may e.g. be used for compensating for a hearing-impaired person's loss of hearing capability, augmenting or protecting a normal-hearing person's hearing capability and/or conveying electronic audio signals to a person. Hearing aids or hearing aid systems may e.g. form part of or interact with public-address systems, active ear protection systems, handsfree telephone systems, car audio systems, entertainment (e.g. TV, music playing or karaoke) systems, teleconferencing systems, classroom amplification systems, etc.

The invention is set out in the appended set of claims.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIG. 1 schematically shows a first exemplary embodiment of a hearing aid system according to the present disclosure.

FIG. 2 schematically shows a second exemplary embodiment of a hearing aid system according to the present disclosure.

FIG. 3 schematically shows a third exemplary embodiment of a hearing aid system according to the present disclosure comprising a hearing aid and an auxiliary device configured to wirelessly communicate.

FIG. 4 schematically shows a fourth exemplary embodiment of a hearing aid system according to the present disclosure, and wherein the hearing aid user provides user feedback.

FIG. 5 schematically shows a fifth exemplary embodiment of a hearing aid system according to the present disclosure comprising a hearing aid, an auxiliary device and a camera system configured to wirelessly communicate.

FIG. 6 schematically shows a method for providing an auditory output signal according to the present disclosure.

FIG. 7 schematically shows an exemplary illustration of a sound environment comprising a hearing aid user USER of a hearing aid system of the present disclosure, a target speaker TRG, and noise sources NOI.

The figures are schematic and simplified for clarity, and they just show details which are essential to the understanding of the disclosure, while other details are left out. Throughout, the same reference signs are used for identical or corresponding parts.

Further scope of applicability of the present disclosure will become apparent from the detailed description given hereinafter. However, it should be understood that the detailed description and specific examples, while indicating preferred embodiments of the disclosure, are given by way of illustration only. Other embodiments may become apparent to those skilled in the art from the following detailed description.

### DETAILED DESCRIPTION OF EMBODIMENTS

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

The electronic hardware may include micro-electronic-mechanical systems (MEMS), integrated circuits (e.g. application specific), microprocessors, microcontrollers, digital signal processors (DSPs), field programmable gate arrays (FPGAs), programmable logic devices (PLDs), gated logic, discrete hardware circuits, printed circuit boards (PCB) (e.g. flexible PCBs), and other suitable hardware configured to perform the various functionality described throughout this disclosure, e.g. sensors, e.g. for sensing and/or registering physical properties of the environment, the device, the user, etc. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The present application relates to the field of hearing aids systems.

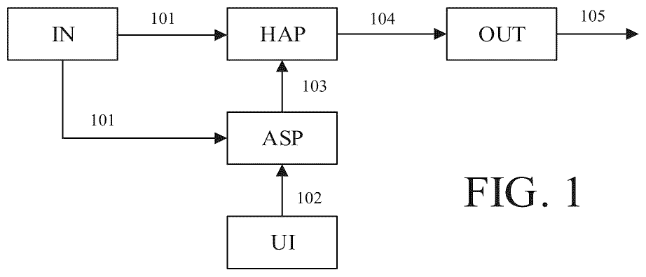

FIG. 1 shows an exemplary block diagram of an example hearing aid system according to the present disclosure. The hearing aid system comprises an input unit IN comprising a microphone. The microphone is configured to pick-up sound of a sound environment. The input unit IN provides an audio input signal 101 based on the audio. The hearing aid system comprises a user interface UI configured to receive a user interaction indicative of a listening difficulty. The user interface UI is configured to provide a listening difficulty indication 102. The auxiliary sound processor ASP is configured to provide a simulated audio signal 103 based on the listening difficulty indication 102 and the audio input signal 101. The hearing aid system comprises an auxiliary sound processor ASP. The hearing aid system is configured to operate in a normal mode of operation and a practice mode of operation. In the normal mode of operation, the hearing aid processor HAP is configured to provide a processed audio signal 104 based on an enhanced speech signal determined based on the audio input signal 101. In the practice mode of operation, the auxiliary sound processor ASP is configured to provide a processed signal 104 based on the simulated audio signal 103 and the enhanced speech signal. The processed signal 104 is determined based on a linear combination of the enhanced speech signal and the simulated audio signal 103, and where the linear combination uses at least one weight with a value between ‘0’ and ‘1’. The hearing aid system comprises an output unit OUT comprising a loudspeaker. The output unit OUT is configured to provide an auditory output signal 105 based on the processed signal 104. The auditory output signal 105 being audible for a hearing aid user.

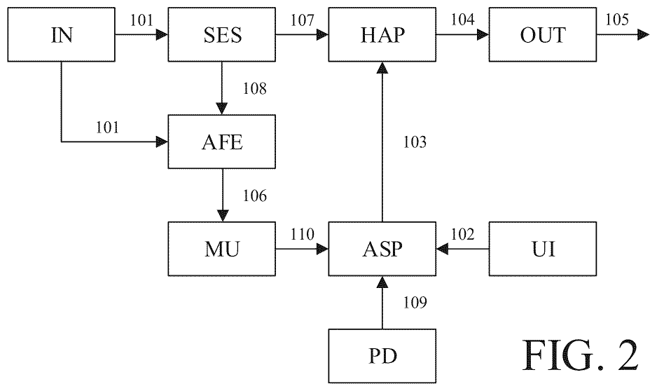

FIG. 2 shows an exemplary block diagram of an example hearing aid system according to the present disclosure. The hearing aid system comprises an input unit IN comprising a microphone. The microphone is configured to pick-up sound of a sound environment. The input unit IN provides an audio input signal 101 based on the audio. The hearing aid system comprises a speech enhancement system SES configured to receive the audio input signal 101 or a processed version thereof and provide an enhanced speech signal 107. The speech enhancement system SES is configured to determine at least one speech enhancement parameter 108 used to determine enhanced speech signal 107. The hearing aid system comprises an acoustic feature extractor AFE configured to provide a plurality of acoustic features 106 based on the audio input signal and the at least one speech enhancement parameter 108. The hearing aid system comprises a memory unit MEM configured to store the acoustic features 106 in a recording mode of operation. The hearing aid system enters the recording mode of operation when a listening difficulty indication 102 provided by a user interface UI is indicative of a high listening difficulty. The memory unit MU is configured to provide a plurality of stored acoustic features 110 received by an auxiliary sound processor ASP. The hearing aid system comprises a personalization database PD comprising acoustic information about the hearing aid user such as head-related transfer functions and voice characteristics. The personalization database PD is configured to provide personalization data. The auxiliary sound processor ASP is configured to provide a simulated audio signal 103 based on the personalization data and 109 stored acoustic features 110. The hearing aid system comprises a hearing aid processor HAP. The hearing aid system is configured to operate in a normal mode of operation and a practice mode of operation. In the normal mode of operation, the hearing aid processor HAP is configured to provide a processed audio signal 104 based on an enhanced speech signal 107 determined based on the audio input signal 101. In the practice mode of operation, the auxiliary sound processor ASP is configured to provide a processed signal 104 based on the simulated audio signal 103 and the enhanced speech signal 107. The processed signal 104 is determined based on a linear combination of the enhanced speech signal 107 and the simulated audio signal 103. The hearing aid system is in the recording mode of operation configured to provide the processed audio signal 104 based on an enhanced speech signal 107. The hearing aid system comprises an output unit OUT comprising a loudspeaker. The output unit OUT is configured to provide an auditory output signal 105 based on the processed signal 104.

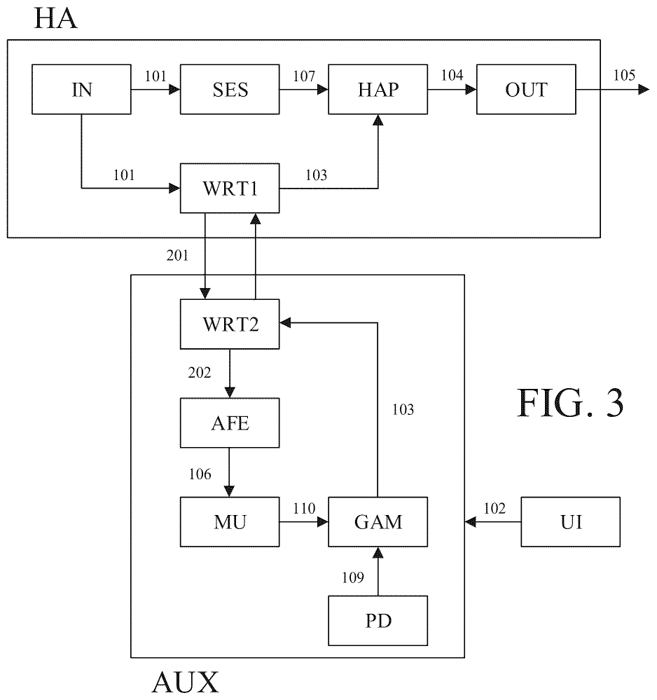

FIG. 3 shows an exemplary block diagram of an example hearing aid system according to the present disclosure. The hearing aid system comprises a hearing aid HA and an auxiliary device AUX. The hearing aid HA an input unit IN comprising a microphone. The microphone is configured to pick-up sound of a sound environment. The input unit IN provides an audio input signal 101 based on the audio. The hearing aid HA comprises a speech enhancement system SES configured to receive the audio input signal 101 or a processed version thereof and provide an enhanced speech signal 107. The speech enhancement system SES is configured to determine at least one speech enhancement parameter 108 used to determine enhanced speech signal 107. The hearing aid HA comprises a first wireless transceiver WRT1. The first wireless transceiver WRT1 is configured to transmit and receive wireless signals 201. The first wireless transceiver WRT1 is configured to transmit audio input signal 101 and at least one speech enhancement parameter 108. In some other embodiments, the first wireless transceiver WRT1 is configured to only transmit at least one speech enhancement parameter 108. The auxiliary device AUX comprises a second wireless transceiver WRT2. The second wireless transceiver WRT2 is configured to transmit and receive wireless signals 202. The second wireless transceiver WRT2 is configured receive the audio input signal 101 and the at least one transmitted speech enhancement parameter 108. The auxiliary device AUX comprises an acoustic feature extractor AFE. The acoustic feature extractor AFE is configured to provide a plurality of acoustic features 106 based on the audio input signal 101 and the at least one transmitted speech enhancement parameter 108. The auxiliary device AUX comprises a memory unit MU configured to receive the acoustic features 106. The memory unit MEM is configured to store the acoustic features 106 in a recording mode of operation. The hearing aid system enters the recording mode of operation when a listening difficulty indication 102 provided by a user interface UI is indicative of a high listening difficulty. The auxiliary device comprises an auxiliary sound processor comprising a generative audio model GAM configured to receive the stored acoustic features 110 and personalized data 109 from a personalization database PD. The generative audio model GAM may be a trained artificial neural network configured to provide a simulated audio signal 103 based on a plurality of stored acoustic features 110 and personalized data 109. The second wireless transceiver WRT2 is configured to transmit the simulated audio signal 103. The first wireless transceiver WRT1 is configured to receive the transmitted simulated audio signal 203. The hearing aid HA comprises a hearing aid processor HAP configured to provide a processed signal 104. The hearing aid system is configured to operate in a normal mode of operation and a practice mode of operation. In the normal mode of operation, the hearing aid processor HAP is configured to provide a processed audio signal 104 based on an enhanced speech signal 107 determined based on the audio input signal 101. In the practice mode of operation, the auxiliary sound processor ASP is configured to provide a processed signal 104 based on the simulated audio signal 103 and the enhanced speech signal 107. The processed signal 104 is determined based on a linear combination of the enhanced speech signal 107 and the simulated audio signal 103. The hearing aid system is in the recording mode of operation configured to provide the processed audio signal 104 based on an enhanced speech signal 107. The hearing aid system comprises an output unit OUT comprising a loudspeaker. The output unit is configured to provide an auditory output signal 105 based on the processed signal 104.

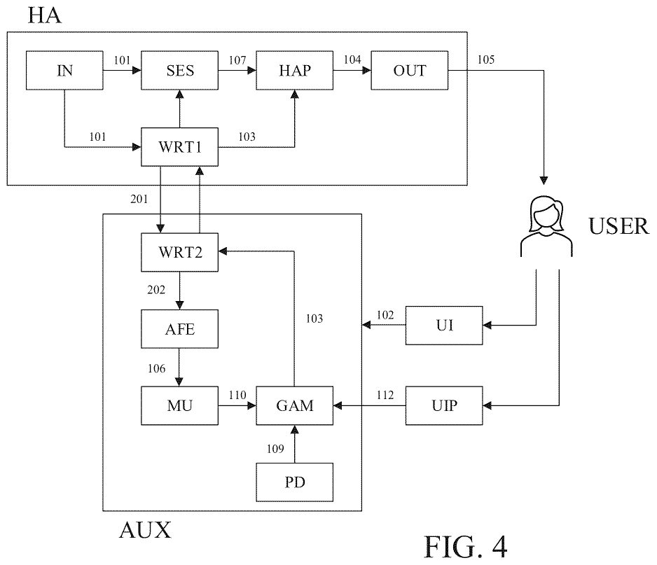

FIG. 4 shows an exemplary block diagram of an example hearing aid system according to the present disclosure. The hearing aid system comprises a hearing aid HA and an auxiliary device AUX. The hearing aid system comprises a user interface UI and a user input panel UIP. The user interface may be physical button on the hearing aid and the user input panel may be a front-end user interface of an app of a smartphone. The user interface is configured to provide a listening difficulty indication. The listening difficulty indication may be based on the hearing aid user USER pressing the physical button to indicate a high listening difficulty. The hearing aid system may enter the recording mode of operation when the listening difficulty is high and wherein the memory unit MU stores the acoustic features and/or audio input signals. In some other embodiments, the acoustic feature extractor may constitute the hearing aid HA, and wherein the hearing aid transmits only the acoustic features. The hearing aid may exit the recording mode after a pre-determined timer, e.g., after 20 seconds of being in the recording mode of operation. The hearing aid may operate in the practice mode of operation. The hearing aid user may select the practice mode of operation by interacting with the user input panel UIP. In the practice mode of operation, the auxiliary device is configured to provide an initial simulated audio signal based on the stored acoustic features by the memory unit MU. An auditory sound signal 105 is provided by a loudspeaker of the hearing aid HA, and wherein the auditory sound signal 105 is based on the simulated audio signal 103 being heard by the hearing aid user USER. The hearing aid user USER uses the user input panel UIP to provide a user feedback 112. The auxiliary device AUX comprises an error model EM configured to determine a performance score 402 based on the simulated audio signal 401 and the user feedback 112. In a particular embodiment, the user feedback 112 is a text string indicative of the words being said in simulated audio 401 signal comprising a desired speech signal. The error model EM is configured to receive the text string and a pre-determined text string by the generative audio model GAM. The pre-determined text string 401 comprises the actual, true, words present in the simulated audio signal 401. The error model EM is configured to compare the text string and the pre-determined text string and determine a user performance score based on the number of correctly detected words or letters in the simulated audio signal 401. The error model EM is configured to provide the user performance score 402 to the generative audio model GAM. The personalization database PD is configured to save the user performance score 402. The hearing aid user USER may choose to continue in the practice mode of operation. If the hearing aid user USER continues in the practice mode of operation, the generative audio model GAM is configured to provide the simulated audio signal 103 based on the acoustic features 106, the personalized signals 109 from the personalization database PD, and the user performance score 402. The generative audio model GAM may adjust the difficulty of simulated audio signal based 103 on the user performance score 402. For example, if the user performance score 402 is indicative that the hearing aid user USER struggles at understanding speech in particularly noisy environments, the generative audio model may be configured to adjust the signal-to-noise ratio of the simulated audio signal 103, so that the signal-to-noise ratio is higher. In another example, the user performance score 402 may indicate that the hearing aid user USER struggles at understanding specific types of phonemes in speech, and the generative audio model GAM may be configured to provide simulated audio signal 103 wherein those particular phonemes are more often present. The practice mode of operation may continue until the hearing aid user USER chooses to enter the normal mode of operation. If the hearing aid user USER chooses to enter the normal mode of operation after the practice mode of operation, the user performance scores 402 determined during the practice mode of operation is stored in the personalization database PD or the memory unit MEM. If the hearing aid user USER chooses to enter the normal mode of operation after the practice mode of operation, the auxiliary device AUX is configured to determine at least one speech enhancement parameter based on the user performance scores 402. For example, if the user performance scores 402 indicates that the hearing aid user USER struggles at understanding speech in a particular type of noise, the auxiliary device AUX may be configured at least one speech enhancement parameter 403, so that when that particular type of noise is present in the audio input signal 101 in the normal of operation, then the speech enhancement system SES may provide a larger amount of noise suppression than a default. In the normal mode of operation, the hearing aid HA is configured to provide the auditory output signal 105 based on the enhanced speech signal 107 by the speech enhancement system SES.

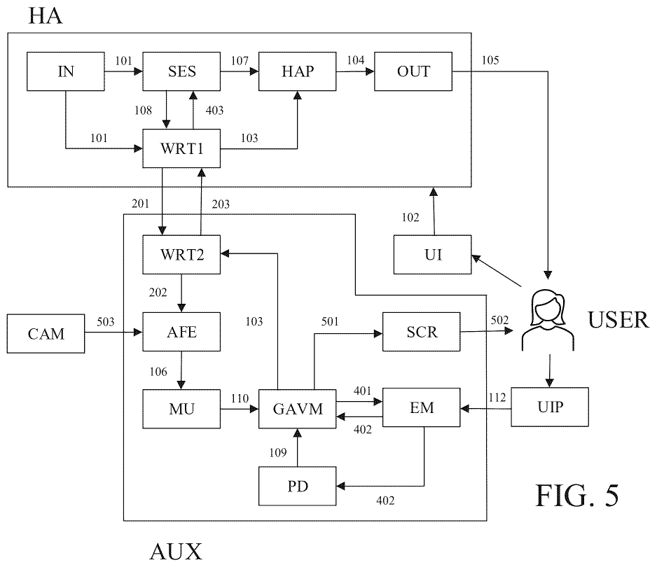

FIG. 5 shows an exemplary block diagram of an example hearing aid system according to the present disclosure. The hearing aid system comprises a hearing aid HA and an auxiliary device AUX. The hearing aid system comprises camera system CAM, configured to provide a visual input signal 503. The auxiliary device AUX is configured to the receive the visual input signal 503 and determine a plurality of acoustic features based on the visual input signal 503 and the transmitted signal by the first wireless transceiver 201. The memory unit MU is configured to store acoustic features when the listening difficulty indication from the user interface 102 is indicative of a high listening difficulty. The auxiliary device AUX comprises a generative audiovisual model GAVM configured to provide a simulated audio signal 103 and a simulated visual signal 501, and wherein the visual and audio cues in the simulated audio signal 103 and simulated visual signal 501 matches. The auxiliary device AUX comprises a screen SCR configured to provide a visual stimulus 502 based on the simulated visual signal 501. The hearing aid HA is configured to provide an auditory output signal 105 based on the simulated audio signal 103. The auditory output signal 105 and the visual stimulus 502 being presented to the user in synchronization.

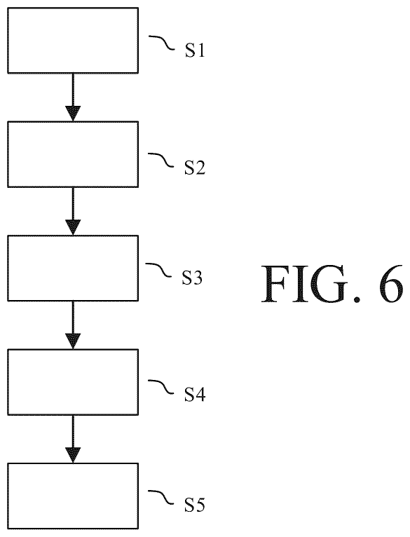

FIG. 6 shows an exemplary block diagram of a method for providing an auditory output signal. The method comprises step S1 which provides, by an input unit comprising an input transducer, an audio input signal indicative of sound of a sound environment. A step S2 which provides, by a user interface, a listening difficulty indication based on an interaction with a user, and wherein the listening difficulty indication is indicative of the user's listening difficulty in the sound environment. A step S3 which provides, by an auxiliary sound processor (ASP), a simulated audio signal (103) based on the listening difficulty indication (102) and a plurality of acoustic features (106) each indicative of an acoustic characteristic of the sound environment, and wherein acoustic features (106) are determined based on the audio input signal (101), and wherein the simulated audio signal (103) is a simulation of the sound environment. A step S4 which provides, by a hearing aid processor (HAP), a processed signal (104) based on the simulated audio signal (103), and step S5 which provides, by an output unit (OUT), an auditory output signal (105) based on the processed signal (104).

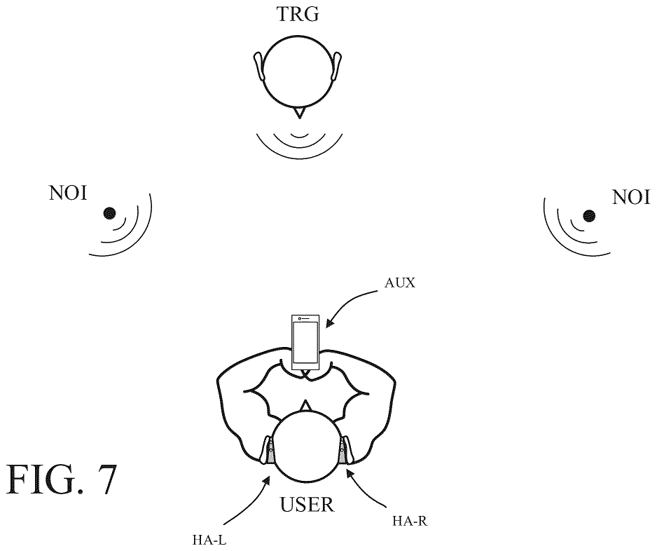

FIG. 7 shows an exemplary situation where a hearing aid user wears a binaural hearing aid comprising a left hearing aid HA-L and a right hearing aid HA-R. The binaural hearing aid is wirelessly connected to an auxiliary device AUX, wherein the auxiliary device may be a smartphone. The hearing aid user is in a sound environment comprising a target speaker TRG generating a desired speech signal, and noise source NOI generating undesired signals. The hearing aids HA-L, HA-R are configured to pick-up the sound from the sound environment. The picked-up sound is a mixture signal of the desired speech signal and the undesired signals. The hearing aids are each configured to provide at least one audio input signal. In this particular embodiment, the auxiliary device AUX comprises a user interface for the hearing aid user to indicate the listening difficulty perceived in the sound environment. If the listening difficulty is perceived to be high, the hearing aid user indicate a high listening difficulty. The hearing aid system comprising the binaural hearing aid and the auxiliary device AUX, may enter a recording mode of operation, and wherein auxiliary device is configured to save a plurality of extracted acoustic features.

It is intended that the structural features of the devices described above, either in the detailed description and/or in the claims, may be combined with steps of the method, when appropriately substituted by a corresponding process.

As used, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element, but an intervening element may also be present, unless expressly stated otherwise. Furthermore, “connected” or “coupled” as used herein may include wirelessly connected or coupled. As used herein, the term “and/or” includes any and all combinations of one or more of the associated listed items. The steps of any disclosed method are not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art.

The claims are not intended to be limited to the aspects shown herein but are to be accorded the full scope consistent with the language of the claims, wherein reference to an element in the singular is not intended to mean “one and only one” unless specifically so stated, but rather “one or more.” Unless specifically stated otherwise, the term “some” refers to one or more.

### Enumerated List of Items

Item 1. A hearing aid system comprising:
an input unit comprising an input transducer configured to provide an audio input signal indicative of sound of a sound environment;
a user interface configured to provide a listening difficulty indication based on an interaction with a user, and wherein the listening difficulty indication is indicative of the user's listening difficulty in the sound environment;
an auxiliary sound processor configured to provide a simulated audio signal based on the listening difficulty indication and a plurality of acoustic features each indicative of an acoustic characteristic of the sound environment, and wherein acoustic features are determined based on the audio input signal, and wherein the simulated audio signal is a simulation of the sound environment;
a hearing aid processor configured to provide a processed signal based on the simulated audio signal; and
an output unit configured to provide an auditory output signal based on the processed signal.

Item 2. A hearing aid system according to item 1, wherein the hearing aid system comprises a speech enhancement system configured to receive the audio input signal and attenuate a noise signal constituting the audio input signal and provide an enhanced speech signal based on a plurality of speech enhancement parameters and the audio input signal, and wherein the speech enhancement parameters are determined based on the audio input signal, and wherein one or more of the acoustic features are determined based on the speech enhancement parameters.

Item 3. A hearing aid system according to any of items 1-2, wherein the hearing aid system comprises a personalization database comprising a plurality of personalization parameters indicative of a user's characteristics, and wherein the auxiliary sound processor is configured to provide the simulated audio signal based on the listening difficulty indication and the audio input signal and personalization parameters.

Item 4. A hearing aid system according to item 2 or 3, wherein the hearing aid system is configured to operate in a normal mode of operation and a practice mode of operation, and wherein the hearing aid system in the normal mode of operation is configured to provide the processed signal based on the enhanced speech signal, and wherein the hearing aid system in the practice mode of operation is configured to provide the processed signal based on the simulated audio signal.

Item 5. A hearing aid system according to item 4, wherein the hearing aid system is configured to operate in a recording mode of operation, and wherein the hearing aid system in the recording mode of operation is configured store the plurality of acoustic features in a memory unit, and wherein the memory unit is configured to provide a plurality of stored acoustic features.

Item 6. A hearing aid system according to item 5, wherein the hearing aid system in the practice mode of operation is configured to provide the simulated audio signal based on the listening difficulty indication and the plurality of stored acoustic features.

Item 7. A hearing aid system according to item 6, wherein the hearing aid system in the practice mode of operation is configured to provide the simulated audio signal based on the listening difficulty indication and the plurality of stored acoustic features, and the personalization parameters.

Item 8. A hearing aid system according to item 7, wherein the hearing aid system is configured to select the mode of operation based on the listening difficulty indication.

Item 9. A hearing aid system according to item 8, wherein the hearing aid system comprises a user input panel configured to receive a user input by the user, and wherein the selected the mode of operation is based on the listening difficulty indication and/or the user input.

Item 10. A hearing aid system according to item 8 or 9, wherein the hearing aid system is configured to select the normal mode of operation or the recording mode of operation based on the listening difficulty indication, and wherein the hearing aid system is configured to select the normal mode of operation if the listening difficulty indication is indicative of a low listening difficulty, and wherein the hearing aid system is configured to select the recording mode of operation if the listening difficulty indication is indicative of a high listening difficulty.

Item 11. A hearing aid system according to item 9 or 10, wherein the hearing aid system is configured to select the practice mode of operation or a non-practice mode of operation based on the user input, and wherein if the practice mode of operation is selected the hearing aid system only operates in the practice mode of operation until the non-practice mode of operation is selected based on the user input, and wherein the hearing aid system in the non-practice mode of operation further operates in the normal mode of operation or the recording mode of operation.

Item 12. A hearing aid system according to item 11, wherein the hearing aid system in the practice mode of operation is configured to present the auditory output signal as sound for the user, and wherein user input panel, in the practice mode of operation, is configured to receive a user feedback indicative of the user's listening difficulty based on the presented auditory output signal.

Item 13. A hearing aid system according to item 12, wherein the hearing aid system comprises an error model configured to determine a user performance score based on the user feedback and an expected feedback, and wherein after receiving the user performance score, the auxiliary sound processor is configured to, in the practice mode of operation, provide a modified simulated audio signal based on the user performance score, and wherein the hearing aid system in a continued use of the practice mode of operation is configured to provide the auditory output signal based on the modified simulated audio signal.

Item 14. A hearing aid system according to items 2-13, wherein the auxiliary sound processor is configured to modify the plurality of speech enhancement parameters based on the simulated audio signal.

Item 15. A hearing aid system according to item 12 or 13, wherein the auxiliary sound processor is configured to modify the plurality of speech enhancement parameters based on the user feedback when the hearing aid system switches from the practice mode of operation to the normal mode of operation.

Item 16. A hearing aid system according to any of items 3-15, wherein the auxiliary sound processor comprises a generative audio model configured to determine the simulated audio signal based on the the audio input signal and the plurality of personalization parameters of the personalization database.

Item 17. A hearing aid system according to item 16, wherein the generative audio model comprises a deep learning model comprising a plurality of deep learning model weights, and wherein the deep learning model is configured to provide the simulated audio signal based on the plurality of acoustic features and deep learning model weights, and wherein the deep learning model weights are determined according to a method of training the deep learning model.

Item 18. A hearing aid system according to item 16, wherein the hearing aid system comprises an audio database comprising a plurality of audio components, and wherein the auxiliary sound processor is configured to select a plurality of audio components of the audio database based on the acoustic features, and wherein the generative audio model is configured to provide the simulated audio signal based on combining the selected audio components.

Item 19. A hearing aid system according to any of items 1-18, wherein the hearing aid system comprises a hearing aid and an auxiliary device.

Item 19. A hearing aid system according to items 3-18, wherein the hearing aid system comprises a hearing aid and an auxiliary device, and wherein the hearing aid comprises the input unit, the hearing aid processor, the speech enhancement system, the user interface, and the output unit, and wherein the auxiliary device comprises, the personalization database, and the auxiliary sound processor.

Item 20. A hearing aid system according to items 3-18, wherein the hearing aid system comprises a hearing aid and an auxiliary device, and wherein the hearing aid comprises the input unit, the hearing aid processor, the speech enhancement system, and the output unit, and wherein the auxiliary device comprises, the personalization database, the user interface, and the auxiliary sound processor.

Item 21. A hearing aid system according to item 19, wherein the hearing aid and the auxiliary device are configured to wirelessly communicate.

Item 22. A hearing aid system according to any one of item 1-11, wherein the user interface comprises a user interface sensor configured to determine a physical interaction of the user on the user interface, and wherein the physical interaction is indicative of the listening difficulty, and wherein user interface is configured to provide the listening difficulty indication based on the physical interaction.

Item 23. A hearing aid system according to item 1-11, wherein the user interface is configured to receive the audio input signal, and wherein the user interface comprises a speech recognition system configured to determine the listening difficulty indication based on the audio input signal.

Item 24. A hearing aid system according to item 1-11, wherein the user interface comprises a body-mounted sensor configured to provide the listening difficulty indication based on a measured fatigue level or cognitive load by the body-mounted sensor.

Item 25. A hearing aid system according to any of items 1-18, wherein the hearing aid system comprises a binaural hearing aid comprising two hearing aids and the auxiliary device.

Item 27. A hearing aid system according to item 1, wherein the input unit comprises a plurality of input transducer each configured to provide an audio input signal, and wherein the plurality of acoustic features are determined based on the plurality of audio input signals.

Item 28. A hearing aid system comprising:
an input unit comprising an input transducer configured to provide an audio input signal indicative of sound of a sound environment;
an auxiliary sound processor configured to determine a plurality of hearing aid settings based on a user performance score, and wherein the user performance score is determined based on a user feedback, and wherein the user feedback is determined during a user training session wherein a plurality of simulated audio signals is presented to the user, and wherein the user provides the of user feedback based on the presented simulated audio signals;
a hearing aid processor configured to provide a processed signal based on the hearing aid settings and the audio input signal; and
an output unit configured to provide an auditory output signal based on the processed signal.

Item 29. A hearing aid system according to item 28, wherein the hearing aid system comprises a user input panel configured to provide a user feedback based on an interaction with a user, and wherein the user feedback is indicative of the user's listening difficulty based on the simulated audio signal.

Item 30. A method for providing an auditory output signal comprising:
providing, by an input unit comprising an input transducer, an audio input signal indicative of sound of a sound environment;
providing, by a user interface, a listening difficulty indication based on an interaction with a user, and wherein the listening difficulty indication is indicative of the user's listening difficulty in the sound environment;
providing, by an auxiliary sound processor, a simulated audio signal based on the listening difficulty indication and a plurality of acoustic features each indicative of an acoustic characteristic of the sound environment, and wherein acoustic features are determined based on the audio input signal, and wherein the simulated audio signal is a simulation of the sound environment;
providing, by a hearing aid processor, a processed signal based on the simulated audio signal; and
providing, by an output unit, an auditory output signal based on the processed signal.

Item 31. A hearing aid system comprising:
an input unit (IN) comprising an input transducer configured to provide an audio input signal (101) indicative of sound of a sound environment;
a user interface (UI) configured to provide a listening difficulty indication (102) based on an interaction with a user, and wherein the listening difficulty indication (102) is indicative of the user's listening difficulty in the sound environment;
a camera system comprising a visual sensor and camera processor, and wherein the visual sensor is configured to capture video and provide a visual signal, and wherein the camera processor is configured to determine at least one visual feature from the visual signal, and wherein the visual feature is indicative of at least one sound object in the sound environment.
an auxiliary sound processor (ASP) configured to provide a simulated audio signal (103) based on the listening difficulty indication (102), the at least one visual feature, and a plurality of acoustic features (106) each indicative of an acoustic characteristic of the sound environment, and wherein acoustic features (106) are determined based on the audio input signal (101), and wherein the simulated audio signal (103) is a simulation of the sound environment;
a hearing aid processor (HAP) configured to provide a processed signal (104) based on the simulated audio signal (103); and
an output unit (OUT) configured to provide an auditory output signal (105) based on the processed signal (104).

1. A hearing aid system comprising a hearing aid and an auxiliary device and wherein the hearing aid comprises:
an input unit comprising an input transducer configured to provide an audio input signal indicative of sound of a sound environment;
a hearing aid processor; and
an output unit;
and wherein the auxiliary device comprises:
an auxiliary sound processor configured to provide a simulated audio signal based on the listening difficulty indication and a plurality of acoustic features each indicative of an acoustic characteristic of the sound environment, and wherein acoustic features are determined based on the audio input signal, and wherein the simulated audio signal is determined based on the plurality of acoustic features and is a simulation of the sound environment;
a user interface, comprising a user input panel configured to receive a user input by the user, and wherein the user interface is configured to provide a listening difficulty indication based the user input, and wherein the listening difficulty indication is indicative of the user's listening difficulty in the sound environment;
and wherein the hearing aid processor is configured to provide a processed signal based on at least the simulated audio signal and wherein the output unit is configured to provide an auditory output signal based on the processed signal;

2. A hearing aid system according to claim 1, wherein the hearing aid system comprises a speech enhancement system configured to receive the audio input signal and attenuate a noise signal constituting the audio input signal and provide an enhanced speech signal based on a plurality of speech enhancement parameters and the audio input signal, and wherein the speech enhancement parameters are determined based on the audio input signal, and wherein one or more of the acoustic features are determined based on the speech enhancement parameters.

3. A hearing aid system according to claim 1, wherein the hearing aid system comprises a personalization database comprising a plurality of personalization parameters indicative of a user's characteristics, and wherein the auxiliary sound processor is configured to provide the simulated audio signal based on the listening difficulty indication and the audio input signal and personalization parameters.

4. A hearing aid system according to claim 2, wherein the hearing aid system is configured to operate in a normal mode of operation and a practice mode of operation, and wherein the hearing aid system in the normal mode of operation is configured to provide the processed signal based on the enhanced speech signal, and wherein the hearing aid system in the practice mode of operation is configured to provide the processed signal based on the simulated audio signal.

5. A hearing aid system according to claim 4, wherein the hearing aid system is configured to operate in a recording mode of operation, and wherein the hearing aid system in the recording mode of operation is configured store the plurality of acoustic features in a memory unit, and wherein the memory unit is configured to provide a plurality of stored acoustic features.

6. A hearing aid system according to claim 5, wherein the hearing aid system is configured to select the recording mode of operation if the listening difficulty indication is indicative of a high-level of listening difficulty.

7. A hearing aid system according to claim 5, wherein the hearing aid system in the practice mode of operation is configured to provide the simulated audio signal based on the listening difficulty indication and the plurality of stored acoustic features.

8. A hearing aid system according to claim 7, wherein the hearing aid system in the practice mode of operation is configured to provide the simulated audio signal based on the listening difficulty indication and the plurality of stored acoustic features, and the personalization parameters.

9. A hearing aid system according to claim 8, wherein the hearing aid system is configured to select the mode of operation based on the listening difficulty indication.

10. A hearing aid system according to claim 9, wherein the selected mode of operation is based on the listening difficulty indication and/or the user input.

11. A hearing aid system according to claim 9, wherein the hearing aid system is configured to select the normal mode of operation or the recording mode of operation based on the listening difficulty indication, and wherein the hearing aid system is configured to select the normal mode of operation if the listening difficulty indication is indicative of a low listening difficulty, and wherein the hearing aid system is configured to select the recording mode of operation if the listening difficulty indication is indicative of a high listening difficulty.

12. A hearing aid system according to claim 11, wherein the hearing aid system in the practice mode of operation is configured to present the auditory output signal as sound for the user, and wherein user input panel, in the practice mode of operation, is configured to receive a user feedback indicative of the user's listening difficulty based on the presented auditory output signal.

13. A hearing aid system according to claim 12, wherein the hearing aid system comprises an error model configured to determine a user performance score based on the user feedback and an expected feedback, and wherein after receiving the user performance score, the auxiliary sound processor is configured to, in the practice mode of operation, provide a modified simulated audio signal based on the user performance score, and wherein the hearing aid system in a continued use of the practice mode of operation is configured to provide the auditory output signal based on the modified simulated audio signal.

14. A hearing aid system according to claim 12, wherein the auxiliary sound processor is configured to modify the plurality of speech enhancement parameters based on the user feedback when the hearing aid system switches from the practice mode of operation to the normal mode of operation.

15. A method for providing an auditory output signal comprising:
providing, by an input unit comprising an input transducer, an audio input signal indicative of sound of a sound environment;
providing, by a user interface comprising a user input panel for receiving a user input by the user, a listening difficulty indication based the user input, and wherein the listening difficulty indication is indicative of the user's listening difficulty in the sound environment;
providing, by an auxiliary sound processor, a simulated audio signal based on the listening difficulty indication and a plurality of acoustic features each indicative of an acoustic characteristic of the sound environment, and wherein acoustic features are determined based on the audio input signal, and wherein the simulated audio signal is determined based on the plurality of acoustic features and is a simulation of the sound environment;
providing, by a hearing aid processor, a processed signal based on the simulated audio signal; and
providing, by an output unit, an auditory output signal based on the processed signal.
